(19) United States
(12) Patent Application Publication
(10) Pub. No.: US 2025/0097892 A1
(43) Pub. Date: Mar. 20, 2025

(54) METHOD FOR SIDELINK POSITIONING, TERMINAL DEVICE, AND NETWORK DEVICE

(71) Applicant: GUANGDONG OPPO MOBILE TELECOMMUNICATIONS CORP., LTD., Dongguan (CN)

(72) Inventors: Hao WANG, Dongguan (CN); Yi DING, Dongguan (CN); Shichang ZHANG, Dongguan (CN)

(73) Assignee: GUANGDONG OPPO MOBILE TELECOMMUNICATIONS CORP., LTD., Dongguan (CN)

(21) Appl. No.: 18/965,580

(22) Filed: Dec. 2, 2024

Related U.S. Application Data
(63) Continuation of application No. PCT/CN2022/111349, filed on Aug. 10, 2022.

(51) Int. Cl. H04W 64/00; H04W 92/18

(52) U.S. Cl. CPC H04W 64/00; H04W 92/18

(57) ABSTRACT

A method for sidelink positioning, a terminal device, and a network device are provided. The method includes: transmitting, by a first terminal device, a first sidelink positioning reference signal to a second terminal device by using a first sidelink resource, where the first sidelink resource is configured by a network device, or the first sidelink resource is selected by the first terminal device or the second terminal device from a sidelink resource pool.

### CROSS-REFERENCE TO RELATED APPLICATIONS

This application is a continuation of International Application No. PCT/CN2022/111349, filed on Aug. 10, 2022, the disclosure of which is hereby incorporated by reference in its entirety.

### TECHNICAL FIELD

This application relates to the field of communications technologies, and more specifically, to a method for sidelink positioning, a terminal device, and a network device.

### BACKGROUND

Currently, how to configure a sidelink resource used for transmitting a sidelink positioning reference signal is not specified in sidelink-based positioning. As a result, sidelink-based positioning cannot be implemented.

### SUMMARY

This application provides a method for sidelink positioning, a terminal device, and a network device. Various aspects used in this application are described below.

According to a first aspect, a method for sidelink positioning is provided, including: transmitting, by a first terminal device, a first sidelink positioning reference signal to a second terminal device by using a first sidelink resource, where the first sidelink resource is configured by a network device, or the first sidelink resource is selected by the first terminal device or the second terminal device from a sidelink resource pool.

According to a second aspect, a method for sidelink positioning is provided, including: receiving, by a second terminal device by using a first sidelink resource, a first sidelink positioning reference signal transmitted by a first terminal device, where the first sidelink resource is configured by a network device, or the first sidelink resource is selected by the first terminal device or the second terminal device from a sidelink resource pool.

According to a third aspect, a method for sidelink positioning is provided, including: transmitting, by a network device, configuration information to a first terminal device and/or a second terminal device, where the configuration information is used to configure a sidelink resource used for transmitting a sidelink positioning reference signal.

According to a fourth aspect, a method for sidelink positioning is provided, including: determining, by a terminal device, a first measurement quantity based on sidelink received timing and sidelink transmitting timing of the terminal device.

According to a fifth aspect, a terminal device is provided, where the terminal device is a first terminal device and includes: a transmitting unit, configured to transmit a first sidelink positioning reference signal to a second terminal device by using a first sidelink resource, where the first sidelink resource is configured by a network device, or the first sidelink resource is selected by the first terminal device or the second terminal device from a sidelink resource pool.

According to a sixth aspect, a terminal device is provided, where the terminal device is a second terminal device and includes: a receiving unit, configured to receive, by using a first sidelink resource, a first sidelink positioning reference signal transmitted by a first terminal device, where the first sidelink resource is configured by a network device, or the first sidelink resource is selected by the first terminal device or the second terminal device from a sidelink resource pool.

According to a seventh aspect, a network device is provided, including: a transmitting unit, configured to transmit configuration information to a first terminal device and/or a second terminal device, where the configuration information is used to configure a sidelink resource used for transmitting a sidelink positioning reference signal.

According to an eighth aspect, a terminal device is provided, including: a processing unit, configured to determine a first measurement quantity based on sidelink received timing and sidelink transmitting timing of the terminal device.

According to a ninth aspect, a terminal device is provided, including a processor, a memory, and a communications interface, where the memory is configured to store one or more computer programs; and the processor is configured to invoke the computer program in the memory, to cause the terminal device to execute some or all of the steps in a method according to the foregoing aspects.

According to a tenth aspect, a network device is provided, including a processor, a memory, and a transceiver, where the memory is configured to store one or more computer programs; and the processor is configured to invoke the computer program in the memory, to cause the network device to execute some or all of the steps in a method according to the foregoing aspects.

According to an eleventh aspect, an embodiment of this application provides a communications system, where the system includes the foregoing terminal device and/or network device. In another possible design, the system may further include another device that interacts with the terminal device or the network device in the solutions provided in embodiments of this application.

According to a twelfth aspect, an embodiment of this application provides a computer-readable storage medium, where the computer-readable storage medium stores a computer program; and the computer program causes a communications device (for example, a terminal device or a network device) to execute some or all of the steps in a method according to the foregoing aspects.

According to a thirteenth aspect, an embodiment of this application provides a computer program product, where the computer program product includes a non-transitory computer-readable storage medium that stores a computer program; and the computer program is operable to cause a communications device (for example, a terminal device or a network device) to execute some or all of the steps in a method according to the foregoing aspects. In some implementations, the computer program product may be a software installation package.

According to a fourteenth aspect, an embodiment of this application provides a chip, where the chip includes a memory and a processor; and the processor may invoke a computer program from the memory and run the computer program, to implement some or all of the steps in a method according to the foregoing aspects.

### BRIEF DESCRIPTION OF DRAWINGS

FIG. 1 is an example diagram of a system architecture of a wireless communications system to which an embodiment of this application is applicable.

FIG. 2 is an example diagram of a scenario of sidelink communication within network coverage.

FIG. 3 is an example diagram of a scenario of sidelink communication with partial network coverage.

FIG. 4 is an example diagram of a scenario of sidelink communication out of network coverage.

FIG. 5 is an example diagram of a scenario of central control node-based sidelink communication.

FIG. 6 is an example diagram of a broadcast-based sidelink communication manner.

FIG. 7 is an example diagram of a unicast-based sidelink communication manner.

FIG. 8 is an example diagram of a multicast-based sidelink communication manner.

FIG. 9 is a schematic diagram of a physical layer structure of sidelink communication.

FIG. 10 is a schematic diagram of a resource reservation manner in sidelink communication.

FIG. 11 is a schematic diagram of a listening-based resource selection method in a sidelink communications system.

FIG. 12 is a schematic diagram of a single-sided RTT-based positioning method.

FIG. 13 is a schematic diagram of a double-sided RTT-based positioning method.

FIG. 14 is a schematic flowchart of a method for sidelink positioning according to an embodiment of this application.

FIG. 15 is a schematic diagram of a method for determining a first time domain location according to an embodiment of this application.

FIG. 16 is a schematic diagram of a method for determining a first time domain location according to another embodiment of this application.

FIG. 17 is a schematic diagram of a method for determining a first time domain location according to still another embodiment of this application.

FIG. 18 is a schematic diagram of a method for determining a first time domain location according to yet another embodiment of this application.

FIG. 19 is a schematic diagram of a method for determining a first time domain location according to still yet another embodiment of this application.

FIG. 20 is a schematic diagram of a method for determining a first time domain location according to a further embodiment of this application.

FIG. 21 is a schematic diagram of a method for determining a first time domain location according to a still further embodiment of this application.

FIG. 22 is a schematic diagram of a method for determining a first time domain location according to a yet further embodiment of this application.

FIG. 23 is a schematic flowchart of a method for sidelink positioning according to another embodiment of this application.

FIG. 24 is a schematic diagram of an RTT-based sidelink positioning method according to an embodiment of this application.

FIG. 25 is a schematic diagram of an RTT-based sidelink positioning method according to another embodiment of this application.

FIG. 26 is a schematic diagram of a terminal device according to an embodiment of this application.

FIG. 27 is a schematic diagram of a terminal device according to another embodiment of this application.

FIG. 28 is a schematic diagram of a network device according to an embodiment of this application.

FIG. 29 is a schematic diagram of a terminal device according to still another embodiment of this application.

FIG. 30 is a schematic structural diagram of a communications apparatus according to an embodiment of this application.

### DESCRIPTION OF EMBODIMENTS

Technical solutions in this application are described below with reference to the accompanying drawings.

### Architecture of a Communications System

FIG. 1 is an example diagram of a system architecture of a wireless communications system 100 to which an embodiment of this application is applicable. The wireless communications system 100 may include a network device 110 and a terminal device 120. The network device 110 may be a device that communicates with the terminal device 120. The network device 110 may provide communication coverage for a specific geographic area, and may communicate with the terminal device 120 located within the coverage area.

FIG. 1 exemplarily shows one network device and one terminal device. Optionally, the wireless communications system 100 may include one or more network devices 110 and/or one or more terminal devices 120. For one network device 110, the one or more terminal devices 120 may be all located within a network coverage range of the network device 110, or may be all located out of a network coverage range of the network device 110, or may be partially located within a coverage range of the network device 110 and partially located out of the network coverage range of the network device 110, which is not limited in embodiments of this application.

Optionally, the wireless communications system 100 may further include other network entities such as a network controller and a mobility management entity, which is not limited in embodiments of this application.

It should be understood that technical solutions of embodiments of this application may be applied to various communications systems, such as a fifth-generation (5G) system or a new radio (NR), a long term evolution (LTE) system, an LTE frequency division duplex (FDD) system, and an LTE time division duplex (TDD). The technical solutions provided in this application may also be applied to a future communications system, such as a sixth-generation mobile communications system or a satellite communications system.

The terminal device in embodiments of this application may also be referred to as a user equipment (UE), an access terminal, a subscriber unit, a subscriber station, a mobile site, a mobile station (MS), a mobile terminal (MT), a remote station, a remote terminal device, a mobile device, a user terminal, a wireless communications device, a user agent, a user apparatus, or the like. The terminal device in embodiments of this application may be a device providing a user with voice and/or data connectivity, and may be used to connect people, objects, and machines. For example, the terminal device is a handheld device, a vehicle-mounted device, or the like having a wireless connection function. The terminal device in embodiments of this application may be a mobile phone, a tablet computer (Pad), a notebook computer, a palmtop computer, a mobile internet device (MID), a wearable device, a vehicle, a wireless terminal in industrial control, a wireless terminal in self driving, a wireless terminal in remote medical surgery, a wireless terminal in smart grid, a wireless terminal in transportation safety, a wireless terminal in smart city, a wireless terminal in smart home, or the like. For example, the terminal device may act as a scheduling entity that provides a sidelink signal between terminal devices in vehicle to everything (V2X) or device-to-device (D2D) communication, or the like. For example, a cellular phone and a vehicle communicate with each other by using a sidelink signal. A cellular phone and a smart home device communicate with each other, without relaying a communication signal through a base station. Optionally, the terminal device may function as a base station.

The network device in embodiments of this application may be a device for communicating with the terminal device. The network device may also be referred to as an access network device or a radio access network device. For example, the network device may be a base station. The network device in embodiments of this application may be a radio access network (RAN) node (or device) that connects the terminal device to a wireless network. The base station may broadly cover various names in the following, or may be interchangeable with the following names, for example: a NodeB, an evolved NodeB (eNB), a next generation NodeB (gNB), a relay station, an access point, a transmitting and receiving point (TRP), a transmitting point (TP), a master eNodeB (MeNB), a secondary eNodeB (SeNB), a multi-standard radio (MSR) node, a home base station, a network controller, an access node, a wireless node, an access point (AP), a transmission node, a transceiver node, a base band unit (BBU), a remote radio unit (RRU), an active antenna unit (AAU), a remote radio head (RRH), a central unit (CU), a distributed unit (DU), and a positioning node. The base station may be a macro base station, a micro base station, a relay node, a donor node, or the like, or a combination thereof. Alternatively, the base station may be a communications module, a modem, or a chip disposed in the device or the apparatus described above. Alternatively, the base station may be a mobile switching center, a device that functions as a base station in device-to-device (D2D), V2X, or machine-to-machine (M2M) communication, a network side device in a 6G network, a device that functions as a base station in a future communications system, or the like. The base station may support networks with a same access technology or different access technologies. A specific technology and a specific device form used by the network device are not limited in embodiments of this application.

The base station may be fixed or mobile. For example, a helicopter or an unmanned aerial vehicle may be configured to function as a mobile base station, and one or more cells may move depending on a location of the mobile base station. In another example, a helicopter or an unmanned aerial vehicle may be configured to serve as a device that communicates with another base station.

In some deployments, the network device in embodiments of this application may be a CU or a DU, or the network device includes a CU and a DU. The gNB may further include an AAU.

The network device and the terminal device may be deployed on land, including being deployed indoors or outdoors, handheld, or vehicle-mounted, may be deployed on a water surface, or may be deployed on an airplane, a balloon, or a satellite in the air. A scenario in which the network device and the terminal device are located is not limited in embodiments of this application.

### Sidelink Communication in Different Network Coverage Statuses

Sidelink communication means a sidelink-based communications technology. The sidelink communication may be, for example, device-to-device (D2D) or vehicle to everything (V2X) communication. Communication data in a conventional cellular system is received or transmitted between a terminal device and a network device; while sidelink communication supports direct transmission of communication data between terminal devices. Compared with conventional cellular communication, direct transmission of communication data between terminal devices may have higher spectral efficiency and a lower transmission delay. For example, a vehicle-to-everything system uses a sidelink communications technology.

Sidelink communication may be classified, depending on a network coverage status of a terminal device, into sidelink communication within network coverage, sidelink communication within partial network coverage, and sidelink communication out of network coverage.

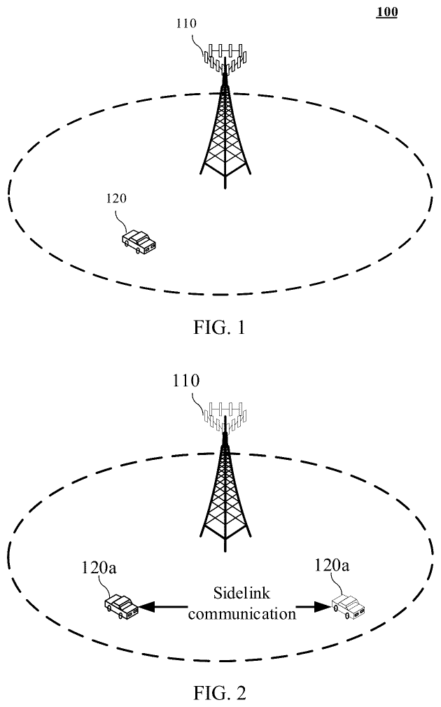

FIG. 2 is an example diagram of a scenario of sidelink communication within network coverage. In the scenario shown in FIG. 2, two terminal devices 120a are both located within coverage of a network device 110. Therefore, both the two terminal devices 120a may receive configuration signalling (where the configuration signalling in this application may alternatively be replaced with configuration information) from the network device 110, and determine a sidelink configuration based on the configuration signalling from the network device 110. After performing sidelink configuration, both the two terminal devices 120a may perform sidelink communication on a sidelink.

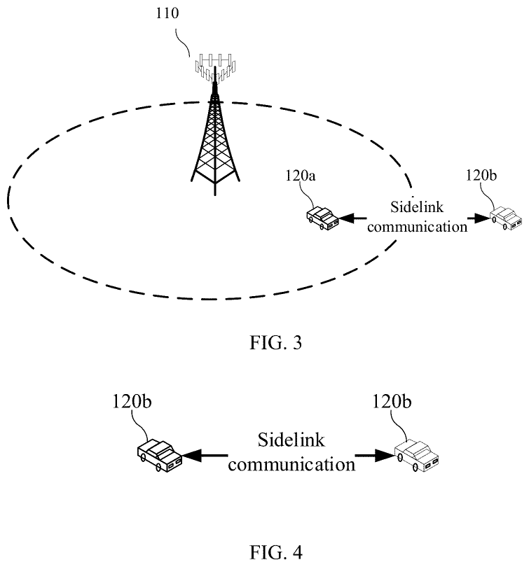

FIG. 3 is an example diagram of a scenario of sidelink communication within partial network coverage. In the scenario shown in FIG. 3, a terminal device 120a performs sidelink communication with a terminal device 120b. The terminal device 120a is located within a coverage range of a network device 110. Therefore, the terminal device 120a can receive configuration signalling from the network device 110, and determine a sidelink configuration based on the configuration signalling from the network device 110. The terminal device 120b is located out of the network coverage range, and thus cannot receive the configuration signalling from the network device 110. In this case, the terminal device 120b may determine a sidelink configuration based on pre-configuration information and/or information that is carried in a physical sidelink broadcast channel (PSBCH) transmitted by the terminal device 120a located within the network coverage range. After both the terminal device 120a and the terminal device 120b perform sidelink configuration, sidelink communication may be performed on a sidelink.

FIG. 4 is an example diagram of a scenario of sidelink communication out of network coverage. In the scenario shown in FIG. 4, two terminal devices 120b are both located out of the network coverage range. In this case, both the two terminal devices 120b may determine a sidelink configuration based on pre-configuration information. After both the two terminal devices 120b perform sidelink configuration, sidelink communication may be performed on a sidelink.

### Central Control Node-Based Sidelink Communication

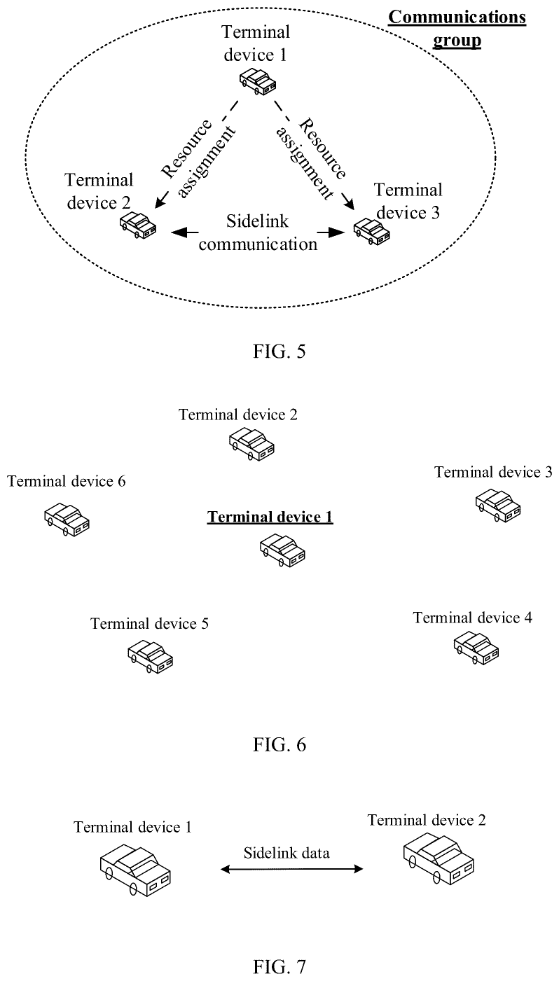

FIG. 5 is an example diagram of a scenario of central control node-based sidelink communication. In the sidelink communication scenario, a plurality of terminal devices may form a communications group; and the communications group has a central control node. The central control node may be a terminal device (for example, a terminal device 1 in FIG. 5) in the communications group; and the terminal device may also be referred to as a cluster header (CH) terminal device. The central control node may be responsible for accomplishing one or more of the following functions: establishment of the communications group; joining and leaving of a group member of the communications group; resource coordination in the communications group; assignment of a sidelink transmission resource to another terminal device; reception of sidelink feedback information from another terminal device; or resource coordination with another communications group.

### Modes of Sidelink Communication

Two modes of sidelink communication are defined in some standards or protocols (for example, 3rd Generation Partnership Project (3GPP)): a first mode and a second mode.

In the first mode, a resource (the resource mentioned in this application may also be referred to as a transmission resource, such as a time-frequency resource) of a terminal device is allocated by a network device. The terminal device may transmit data on a sidelink based on the resource allocated by the network device. The network device may allocate, to the terminal device, a resource for single transmission; or may allocate, to the terminal device, a resource for semi-static transmission. The first mode may be applied to a scenario in which there is coverage of the network device, for example, the scenario shown in FIG. 2 above. In the scenario shown in FIG. 2, the terminal device 120a is located within a network coverage range of the network device 110. Therefore, the network device 110 may allocate, to the terminal device 120a, a resource used in a sidelink transmission process.

In the second mode, a terminal device may autonomously select one or more resources from a resource pool (RP). Then, the terminal device may perform sidelink transmission based on the selected resource. For example, in the scenario shown in FIG. 4, the terminal device 120b is located out of a cell coverage range. Therefore, the terminal device 120b may autonomously select a resource from a pre-configured resource pool to perform sidelink transmission. Alternatively, in the scenario shown in FIG. 2, the terminal device 120a may autonomously select one or more resources from a resource pool configured by the network device 110 to perform sidelink transmission.

### Data Transmission Manners of Sidelink Communication

Some sidelink communications systems (for example, long term evolution vehicle to everything (LTE-V2X)) support a broadcast-based data transmission manner (hereinafter referred to as broadcast transmission). For broadcast transmission, a receiving end terminal may be any terminal device around a transmitting end terminal. For example, in FIG. 6, a terminal device 1 is the transmitting end terminal; and a receiving end terminal corresponding to the transmitting end terminal is any terminal device around the terminal device 1, for example, may be any one of a terminal device 2 to a terminal device 6 in FIG. 6.

In addition to the broadcast transmission, some communications systems also support a unicast-based data transmission manner (hereinafter referred to as unicast transmission) and/or a multicast-based data transmission manner (hereinafter referred to as multicast transmission). For example, new radio vehicle to everything (NR-V2X) expects to support autonomous driving. Autonomous driving poses higher requirements for data interaction between vehicles. For example, data interaction between vehicles requires a higher throughput, a lower delay, higher reliability, a larger coverage range, a more flexible resource allocation manner, or the like. Therefore, to improve performance of data interaction between vehicles, NR-V2X introduces unicast transmission and multicast transmission.

For unicast transmission, a receiving end terminal generally has only one terminal device. For example, in FIG. 7, unicast transmission is performed between a terminal device 1 and a terminal device 2. The terminal device 1 may be a transmitting end terminal, and the terminal device 2 may be a receiving end terminal. Alternatively, the terminal device 1 may be a receiving end terminal, and the terminal device 2 may be a transmitting end terminal.

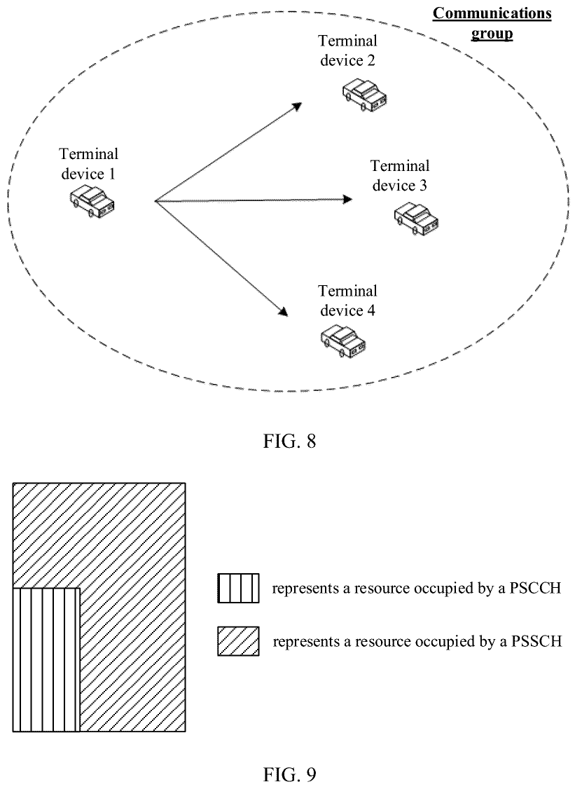

For multicast transmission, a receiving end terminal may be a terminal device in a communications group, or a receiving end terminal may be a terminal device within a specific transmission distance. For example, in FIG. 8, a terminal device 1, a terminal device 2, a terminal device 3, and a terminal device 4 constitute a communications group. If the terminal device 1 transmits data, all the other terminal devices (the terminal device 2 to the terminal device 4) in the group may be receiving end terminals.

### Physical Layer Structure of Sidelink Communication

FIG. 9 is a schematic diagram of a physical layer structure of sidelink communication. Refer to FIG. 9. A physical sidelink control channel (PSCCH) may be used to carry first sidelink control information. A physical sidelink shared channel (PSSCH) may be used to carry sidelink data and second sidelink control information. The PSCCH and the PSSCH may be multiplexed into a same slot for transmitting.

The first sidelink control information (SCI) is carried in the PSCCH, and mainly includes a field related to resource listening, which is used by another terminal for resource exclusion and resource selection after decoding. In addition to the sidelink data, the PSSCH may further carry the second sidelink control information, where the second sidelink control information mainly includes a field related to data demodulation, which is used by a receiving terminal to demodulate data carried in a PSSCH associated with the PSCCH.

### Resource Reservation of Sidelink Communication

With reference to the foregoing descriptions of the modes of sidelink communication, in the second mode, a terminal device may autonomously select a sidelink resource to transmit data. Resource reservation may be understood as a prerequisite for supporting resource selection by the terminal device. Resource reservation means that the terminal device may reserve a selected sidelink resource (for example, a time-frequency resource) in first sidelink control information carried in a PSCCH.

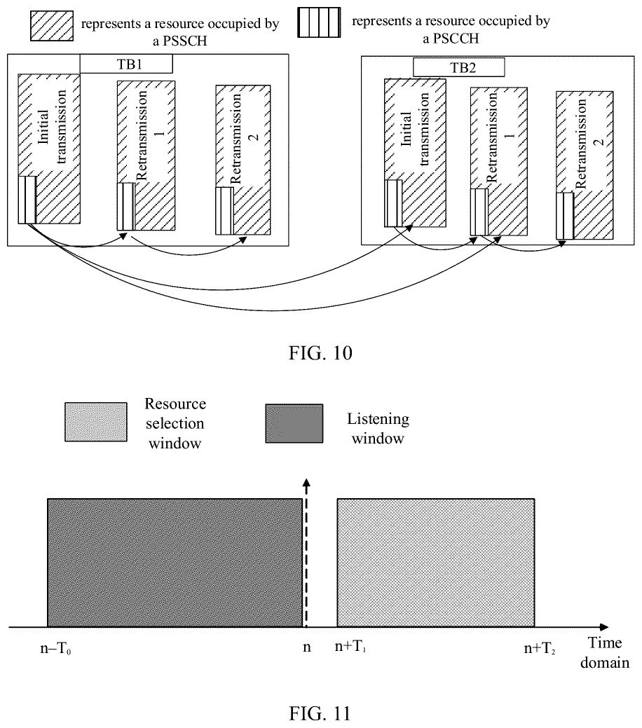

Currently, in a sidelink communications system, not only intra-TB resource reservation but also inter-TB resource reservation is supported. The following provides a description with reference to FIG. 10.

Refer to FIG. 10. The terminal device transmits first SCI, and indicates, by using a time resource assignment field and a frequency resource assignment field in the first SCI, N time-frequency resources (including a time-frequency resource used for transmitting a transport block (TB) currently) used for current TB transmission. Generally, N≤Nmax. In NR V2X, Nmax is equal to 2 or 3. In addition, the foregoing N indicated time-frequency resources may be distributed in W slots. In NR V2X, W is equal to 32.

Still refer to FIG. 10. In a process of transmitting a TB 1, the terminal device may transmit the first SCI in a PSCCH while transmitting initial transmission data in the PSSCH, and indicate time-frequency resource locations for initial transmission and retransmission 1 (that is, N=2 in this case) by using the foregoing two fields in the first SCI, that is, reserve a time-frequency resource for retransmission 1. Generally, initial transmission and retransmission 1 are distributed in the 32 slots in time domain.

Similarly, still refer to FIG. 10. In the process of transmitting the TB 1, the terminal device may indicate time-frequency resources for retransmission 1 and retransmission 2 by using the first SCI transmitted in the PSCCH of retransmission 1. The time-frequency resources for retransmission 1 and retransmission 2 may be distributed in the 32 slots in time domain.

In addition, when transmitting the first SCI, the terminal device may perform inter-TB resource reservation by using a resource reservation period field in the first SCI.

Still refer to FIG. 10. When transmitting the first SCI that indicates an initial transmission resource of the TB 1, the terminal device may indicate the time-frequency resource locations for initial transmission and retransmission 1 of the TB 1 by using the time resource assignment field and the frequency resource assignment field in the first SCI, and denote them as {(t1, f1), (t2, f2)}, where t1 and t2 denote time domain locations of resources for initial transmission and retransmission 1 of the TB 1; and f1 and f2 denote frequency domain locations of the resources for initial transmission and retransmission 1 of the TB 1. If a value of the resource reservation period field in the first SCI is 100 milliseconds, the first SCI indicates both time-frequency resources {(t1+100, f1), (t2+100, f2)}. The two resources are used for initial transmission and retransmission 1 of a TB 2.

Similarly, the first SCI transmitted on the resource for retransmission 1 of the TB 1 may also reserve, by using the resource reservation period field, time-frequency resources for retransmission 1 and retransmission 2 of the TB 2. In NR V2X, possible values of the resource reservation period field are 0 milliseconds, 1 to 99 milliseconds, 100 milliseconds, 200 milliseconds, 300 milliseconds, 400 milliseconds, 500 milliseconds, 600 milliseconds, 700 milliseconds, 800 milliseconds, 900 milliseconds, and 1000 milliseconds, which are more flexible than those in LTE V2X. However, in each resource pool, generally, only e of the values are configured. The terminal device may determine, based on the resource pool used, values that may be used. The e values in a configuration of the resource pool are denoted as a resource reservation period set M. For example, e is less than or equal to 16.

In addition, the foregoing inter-TB reservation may be activated or deactivated on a resource pool basis via network configuration or pre-configuration. When the inter-TB reservation is deactivated, the first SCI does not include the resource reservation period field. Generally, a value of the resource reservation period field used by the terminal device, namely, a resource reservation period, does not change before resource reselection is triggered. Each time the terminal device transmits the first SCI, the terminal device reserves, by using the resource reservation period field in the first SCI, a resource for a next period for transmitting another TB, thereby achieving periodic semi-persistent transmission.

When the terminal device operates in the foregoing second mode, the terminal device may obtain, by listening to a PSCCH transmitted by another terminal device, first SCI transmitted by the another terminal device, thereby learning a resource reserved by the another terminal device. When performing resource selection subsequently, the terminal device excludes the resource reserved by the another terminal device, thereby avoiding resource collision. The following describes a listening-based resource selection method in a sidelink communications system with reference to FIG. 11.

### Listening-Based Resource Selection Method

Refer to FIG. 11. A terminal device may trigger resource selection or reselection in a slot n. In some implementations, the slot n may be a slot in which a higher layer triggers a physical layer to report a candidate resource set. A resource selection window starts from n+T₁ and ends at n+T₂, and is represented as [n+T₁ and n+T₂], where 0≤T₁≤T_{proc,1}; when subcarrier spacing is 15 kHz, 30 kHz, 60 kHz, or 120 kHz, T_{proc,1} is 3 slots, 5 slots, 9 slots, or 17 slots, respectively; T₂ₘᵢₙ≤T₂≤Remaining delay budget of a service; a value set of T₂ₘᵢₙ is {1, 5, 10, 20}*2μ slots; and μ being 0, 1, 2, or 3 corresponds to a case in which the subcarrier spacing is 15 kHz, 30 kHz, 60 kHz, or 120 kHz, respectively. The terminal device determines T₂ₘᵢₙ from the value set based on a priority of data to be transmitted by itself. For example, when the subcarrier spacing is 15 kHz, the terminal device determines T₂ₘᵢₙ from the set {1, 5, 10, 20} based on the priority of data to be transmitted by itself. When T₂ₘᵢₙ is greater than or equal to the remaining delay budget of the service, T₂ is equal to the remaining delay budget of the service. The remaining delay budget is a difference between a current instant and an instant corresponding to a delay requirement of the data. For example, for a data packet arriving in the slot n, the delay requirement is 50 milliseconds. It is assumed that one slot is 1 millisecond. If the current instant is the slot n, the remaining delay budget is 50 milliseconds. If the current instant is a slot n+20, the remaining delay budget is 30 milliseconds.

Before resource selection, the terminal device needs to perform resource listening in a listening window ranging from n-T₀ to n-T_{proc,0}, where a value of T₀ is 100 milliseconds or 1100 milliseconds. When the subcarrier spacing is 15 kHz, 30 kHz, 60 kHz, or 120 kHz, T_{proc,0} is 1 slot, 1 slot, 2 slots, or 4 slots, respectively. Generally, a terminal device listens, in each slot (except its own transmitting slot), to first SCI transmitted by another terminal device. If resource selection or reselection is triggered in the slot n, the terminal device may use results of resource listening performed at n-T₀ to n-T_{proc,0}. The following describes a resource selection process with reference to Step 1 and Step 2.

Step 1: The terminal device uses, as a resource set A, all candidate available resources that belong to a resource pool used by the terminal device and are in the resource selection window. Specifically, there may be two cases 1-1 and 1-2.

Case 1-1: If the terminal device transmits data but does not perform listening in a slot m in the listening window, the terminal device determines one or more slots based on the slot m and each allowed resource reservation period in the resource pool used by the terminal device, where the resource reservation period is used as an interval. The terminal device needs to exclude all resources at the one or more slots from the resource set A.

Case 1-2: If the terminal device detects, in a slot m in the listening window, first SCI transmitted in a PSCCH, SL-reference signal received power (RSRP) of the PSCCH or SL-RSRP of a PSSCH scheduled by the PSCCH (namely, SL-RSRP of a PSSCH associated with the PSCCH and transmitted at the same slot as the PSCCH) are measured.

If the measured SL-RSRP is greater than an SL-RSRP threshold, the terminal device determines, based on resource reservation information in sidelink control information transmitted in the PSCCH, resources reserved by the PSCCH. If the reserved resources are in the resource set A, the terminal device excludes these reserved resources from the set A.

If resources remaining in the resource set A after resource exclusion account for less than X % of all resources in the resource set A before resource exclusion, the SL-RSRP threshold is raised by 3 dB, and Step 1 is performed again. The physical layer reports the resource set A after resource exclusion as the candidate resource set to the higher layer.

Step 2: The higher layer randomly selects a resource from the reported candidate resource set to transmit data. In other words, the terminal device randomly selects a resource from the candidate resource set to transmit data.

It should be noted that the foregoing RSRP threshold is determined based on a priority P1 carried in the PSCCH detected by the terminal device and a priority P2 of data to be transmitted by the terminal device.

In addition, whether the terminal device performs comparison with the SL-RSRP threshold by using the measured PSCCH-RSRP or by using the PSSCH-RSRP scheduled by the PSCCH depends on a resource pool configuration of the resource pool used by the terminal device. The configuration of the resource pool may be a configuration or pre-configuration provided by a network.

It should be further noted that possible values of X are {20%, 35%, 50%}. The configuration of the resource pool used by the terminal device includes a correspondence between priorities and the foregoing possible values. The terminal device determines a value of X based on the correspondence and a priority of data to be transmitted. The resource pool configuration may be a configuration or pre-configuration provided by a network.

### Sidelink-Based Positioning

Sidelink-based positioning is one of enhancement solutions of the R18 positioning technology. This topic considers scenarios and requirements that support NR positioning use cases within, partially with and outside coverage of a cellular network; considers positioning requirements of V2X use cases, public safety use cases, commercial use cases, and industrial internet of things (IIOT) use cases; considers supporting the following functions: absolute positioning, ranging/direction finding, and relative positioning; study of a positioning method combining a sidelink measurement quantity and a Uu interface measurement quantity; study of a sidelink positioning reference signal, including signal design, physical layer control signalling, resource allocation, a physical layer measurement quantity, a related physical layer process, and the like; and study of a positioning system architecture and a signalling process, for example, a configuration, measurement reporting, and the like.

For absolute positioning, a terminal device may directly determine its own absolute geography based on a measurement result, or absolute positioning is referred to as absolute positioning based on a terminal device. Alternatively, the terminal device may report a measurement result to a positioning server, for example, an LMF; and then, the LMF calculates an absolute location of the terminal device and notifies the terminal device of the absolute location. This manner is referred to as absolute positioning assisted by the terminal device. For ranging/direction finding or relative positioning, the terminal device may estimate, based on a received positioning reference signal, information about the signal, such as a round-trip time, an angle of arrival, and signal received power of the signal, thereby estimating a relative distance and a relative direction.

### Principle of a Round-Trip Time (RTT) Positioning Method

In an RTT-based positioning method, at least two devices are required to participate in a positioning process. One of the two devices is a target device, namely, a device that needs to be positioned; and the other device may serve as a reference device, namely, a device that may assist the target device in completing positioning. Generally, a location of the reference device may be known.

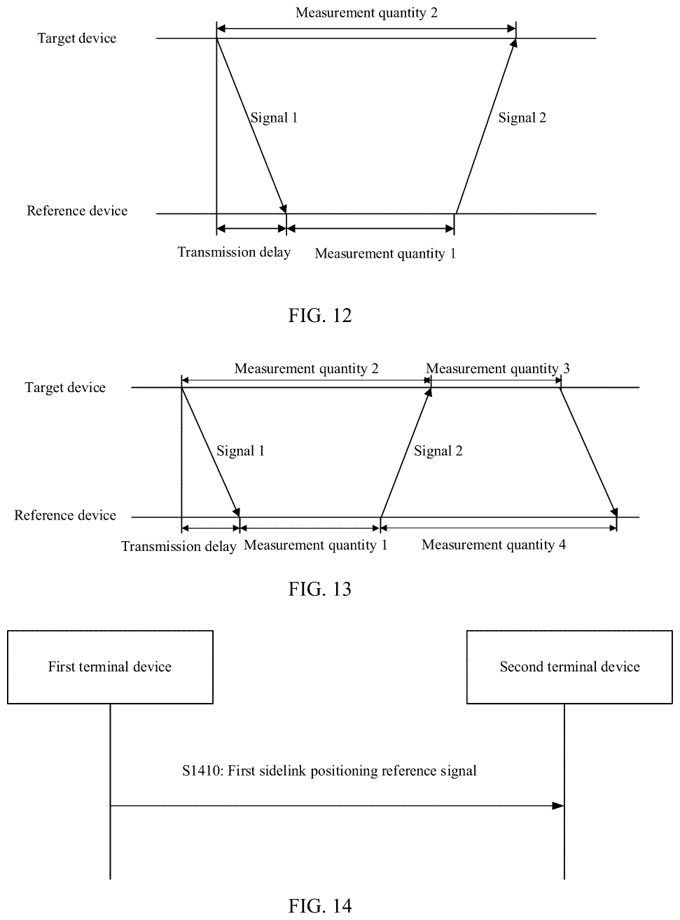

Currently, RTT-based positioning methods may be classified into single-sided RTT positioning methods and double-sided RTT positioning methods, which are separately described below with reference to FIG. 12 and FIG. 13.

As shown in FIG. 12, the target device and the reference device may obtain values of a measurement quantity 1 and a measurement quantity 2 based on times at which a signal 1 and a signal 2 are transmitted and received. In this case, a transmission delay T between the target device and the reference device may be estimated by dividing (Measurement quantity 2−Measurement quantity 1) by 2; and then, a relative distance between the target device and the reference device may be obtained by multiplying the transmission delay by a speed of light.

In the foregoing single-sided RTT-based positioning method, a measurement quantity error may be caused because of a clock offset error between the two devices. Currently, a double-sided RTT-based positioning manner may reduce a measurement error caused by a clock offset.

Refer to FIG. 13. Compared with the single-sided RTT method, after receiving the signal 2 transmitted by the reference device, the target device needs to further transmit a signal 3 to the reference device once. Due to three times of signal transmission, four measurement quantities: a measurement quantity 1, a measurement quantity 2, a measurement quantity 3, and a measurement quantity 4 may be obtained. Correspondingly, a method for calculating a transmission delay between the target device and the reference device is as follows: Transmission delay=(Measurement quantity 2*Measurement quantity 4−Measurement quantity 1*Measurement quantity 3)/(Measurement quantity 1+Measurement quantity 2+Measurement quantity 3+Measurement quantity 4).

In embodiments of this application, if the foregoing RTT positioning solution is used in sidelink positioning, the target device and the reference device may be terminal devices. For example, the target device may be the first terminal device described below; and correspondingly, the reference device may be the second terminal device described below. For another example, the target device may be the second terminal device described below; and correspondingly, the reference device may be the first terminal device described below.

In addition, a signal transmitted between the target device and the reference device may be a signal used for positioning, for example, a sidelink positioning reference signal (SL PRS). Correspondingly, the foregoing signal 1 may be a second SL PRS; the foregoing signal 2 may be a first SL PRS; and the foregoing signal 3 may be a third SL PRS. Certainly, another signal may also be used in embodiments of this application, which is not limited in embodiments of this application.

It should be further noted that, in embodiments of this application, a sidelink resource for transmitting the foregoing SL PRS may be referred to as an “SL PRS resource”. Correspondingly, a sidelink resource for transmitting the second SL PRS (namely, a second sidelink resource) may be referred to as a “second SL PRS resource”; a sidelink resource for transmitting the first SL PRS (namely, a first sidelink resource) may be referred to as a “first SL PRS resource”; and a sidelink resource for transmitting the third SL PRS (namely, a third sidelink resource) may be referred to as a “third SL PRS resource”.

In addition, a transmitting end of the foregoing signal 1 may be a target device, or may be a reference device. This is not limited in embodiments of this application.

Currently, how to configure a sidelink resource used for transmitting a sidelink positioning reference signal is not specified in sidelink-based positioning. Therefore, in view of the above problem, an embodiment of this application provides a method for sidelink positioning. In embodiments of this application, the first sidelink positioning reference signal may be transmitted based on the first sidelink resource that is configured by the network device or independently selected by the terminal device from the sidelink resource pool, which is beneficial to implement sidelink-based positioning. A method for sidelink positioning according to an embodiment of this application is described below with reference to FIG. 14.

FIG. 14 is a schematic flowchart of a method for sidelink positioning according to an embodiment of this application. The method shown in FIG. 14 includes Step S1410.

In Step S1410, a first terminal device transmits a first sidelink positioning reference signal to a second terminal device by using a first sidelink resource.

In some implementations, the first sidelink resource is configured by a network device. For example, the first sidelink resource may be allocated in the first mode described above. In some other implementations, the first sidelink resource may be selected by the first terminal device or the second terminal device from a sidelink resource pool. For example, the first sidelink resource may be allocated in the second mode described above.

The foregoing first sidelink resource is used to transmit the first sidelink positioning reference signal. Therefore, the first sidelink resource may also be referred to as an “SL PRS resource”. In some implementations, the SL PRS resource may belong to an SL PRS resource pool. The SL PRS resource pool may be a shared resource pool, that is, some or all of SL PRS resources in the SL PRS resource pool may be used by another terminal device to perform sidelink communication. For example, the another terminal device may use an SL PRS resource to transmit at least one of a PSCCH, a PSSCH, or a PSFCH. Certainly, in embodiments of this application, the foregoing SL PRS resource may alternatively be a dedicated resource pool, that is, an SL PRS resource in the SL PRS resource pool is used to transmit only an SL PRS.

In some scenarios, a plurality of sidelink resources are required to transmit the sidelink positioning reference signal, to position a target terminal device. In this case, if time domain locations corresponding to the plurality of sidelink resources are not limited, the distance between the latest sidelink resource and the earliest sidelink resource in the plurality of sidelink resources may be relatively long, so that it takes a relatively long time to position the target terminal device. As a result, positioning efficiency of the target terminal device is relatively low.

For example, refer to FIG. 12. In a process of performing sidelink positioning based on single-sided RTT positioning, SL PRS transmission needs to be performed twice between the target terminal device and a reference terminal device, where the first sidelink resource is used for transmitting an SL PRS 1; and a second sidelink resource is used for transmitting an SL PRS 2. When the second sidelink resource is relatively far away from the first sidelink resource in time domain, two measurement quantities obtained via the two times of SL PRS transmission may not match each other because locations of the terminal devices drift. As a result, positioning precision of the target terminal device is relatively low.

Therefore, to improve positioning precision of the target terminal device, an embodiment of this application provides a method for determining a first time domain location corresponding to the first sidelink resource.

In some implementations, the first time domain location may be determined based on one or more of the following: a positioning measurement time window of the first terminal device; a positioning measurement time window of the second terminal device; a terminal capability of the first terminal device; a terminal capability of the second terminal device; or a second time domain location.

The positioning measurement time window of the second terminal device may be used to indicate a time period in which the second terminal device expects to receive the first sidelink positioning reference signal. Correspondingly, the first time domain location may be located in a positioning measurement time window of the second terminal device, so that the second terminal device may receive, within an expected time period, the first sidelink positioning reference signal transmitted by using the first sidelink resource corresponding to the first time domain location.

The positioning measurement time window of the first terminal device may be used to indicate a time period in which the first terminal device expects to receive a sidelink positioning reference signal. In this case, the first time domain location may be configured in a positioning measurement time window of the first terminal device, which is beneficial to shorten a time required for positioning.

The terminal capability of the second terminal device may be used to indicate a positioning capability of the second terminal device. In some implementations, the positioning capability of the second terminal device may be used to indicate the positioning measurement time window of the second terminal device. Therefore, based on the foregoing description of the positioning measurement time window, it may be learned that in embodiments of this application, the first time domain location may be determined based on the terminal capability of the second terminal device, so that the second terminal device may receive the first sidelink positioning reference signal within the expected time period.

The terminal capability of the first terminal device may be used to indicate a positioning capability of the first terminal device. In some implementations, the positioning capability of the first terminal device may be used to indicate the positioning measurement time window of the first terminal device. Therefore, based on the foregoing description of the positioning measurement time window, it may be learned that in embodiments of this application, the first time domain location may be determined based on the terminal capability of the first terminal device.

The foregoing second time domain location corresponds to the second sidelink resource. The second sidelink resource is used to transmit a second sidelink positioning reference signal; and the second time domain location is earlier than the first time domain location.

An RTT-based sidelink positioning method is used as an example. The first time domain location corresponding to the first sidelink resource being different from the time domain location corresponding to the second sidelink resource may include a time unit in which the first sidelink resource is located being different from a time unit in which the second sidelink resource is located. The time unit being an OFDM symbol is used as an example. An OFDM symbol occupied by the first sidelink resource is different from an OFDM symbol occupied by the second sidelink resource. The time unit being a slot is used as an example. A slot in which the first sidelink resource is located is different from a slot in which the second sidelink resource is located.

Certainly, in embodiments of this application, alternatively, a frequency domain of the first sidelink resource may be different from a frequency domain of the second sidelink resource; or a code domain of the first sidelink resource may be different from a code domain of the second sidelink resource. This is not limited in embodiments of this application.

For example, refer to FIG. 12. The second time domain location may be a time domain location corresponding to the sidelink resource used for transmitting a PRS 1. Correspondingly, the first time domain location may be a time domain location corresponding to the sidelink resource used for transmitting a PRS 2. In this case, the time domain location of the sidelink resource used for transmitting the PRS 2 may be determined based on the time domain location of the sidelink resource used for transmitting the PRS 1.

In some implementations, the first time domain location being determined based on the second time domain location may include the first time domain location being determined based on the second time domain location and a first parameter, where the first parameter is used to determine a time interval between the first time domain location and the second time domain location.

In some implementations, the foregoing first parameter may be used to determine a time interval between the first time domain location and the second time domain location. In some other implementations, if the first time domain location and the second time domain location are two adjacent time domain locations in a plurality of time domain locations corresponding to the plurality of sidelink resources, the first parameter may be further used to determine a time interval between one pair of adjacent time domain locations in the plurality of time domain locations. Certainly, the foregoing first parameter may be further used to determine a time interval between any two adjacent time domain locations in the plurality of time domain locations. Certainly, the foregoing first parameter may be further used to determine a time interval between the earliest time domain location and the latest time domain location in the plurality of time domain locations. The first parameter is specifically described below with reference to specific resource allocation manners. For brevity, details are not described herein again.

It should be noted that, for two adjacent time domain locations in the plurality of time domain locations, the two adjacent time domain locations are not necessarily consecutive in time domain. In some cases, the two adjacent time domain locations may include one or more time units that are spaced in time domain; and in the spaced time units, there is no time unit that corresponds to another time domain location in the plurality of time domain locations. For example, as shown in FIG. 18 below, the second time domain location corresponding to the second sidelink resource and the first time domain location corresponding to the first sidelink resource may be understood as two adjacent time domain locations.

In some implementations, the foregoing first parameter may indicate a real time interval between the foregoing two time domain locations. In some other implementations, the foregoing first parameter may alternatively indicate a time interval threshold between two time domain locations. The time interval threshold may be, for example, a maximum time interval value. Correspondingly, a real time interval between two time domain locations may be less than or equal to the time interval threshold indicated by the first parameter. The first parameter being used to determine the time interval threshold between the first time domain location and the second time domain location is used as an example. The real time interval between the first time domain location and the second time domain location may be less than or equal to the time interval threshold indicated by the first parameter.

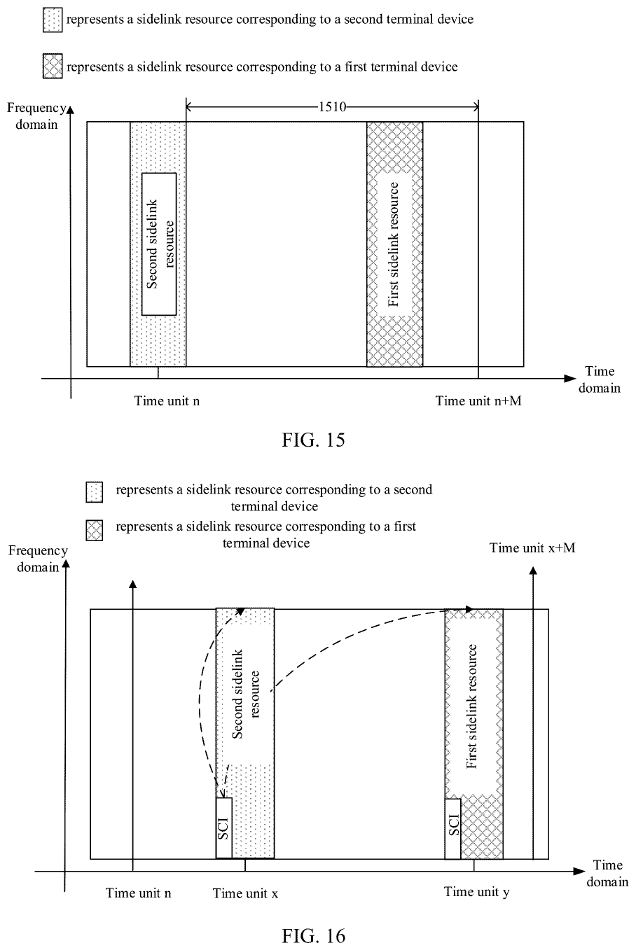

For ease of understanding, the following describes a method according to an embodiment of this application with reference to FIG. 15 by using an example in which the first parameter indicates the time interval threshold. Refer to FIG. 15. Assuming that a time interval indicated by the first parameter is M time units, and the second sidelink resource is a time unit n, the first sidelink resource may be located in a time domain range 1510 that uses the time unit n as a time domain start location and uses a time unit n+M as a time domain end location.

It should be noted that, the time unit n being used as the time domain start location above may be understood as a start location of the time unit n being used as the time domain start location, or may be understood as an end location of the time unit n being used as the time domain start location. Certainly, any location of the time unit n may alternatively be used as the time domain start location. This is not limited in embodiments of this application.

In some implementations, the foregoing first parameter may be determined based on one or more of the following: a pre-definition in a protocol, pre-configuration information, configuration information of the network device, terminal configuration information of the first terminal device, terminal configuration information of the second terminal device, the positioning measurement time window of the first terminal device, or the positioning measurement time window of the second terminal device.

The foregoing terminal configuration information may include, for example, a terminal capability. In some implementations, the terminal capability may be, for example, a terminal positioning capability. The terminal positioning capability may be used to indicate a first parameter supported by the terminal device.

The foregoing positioning measurement time window is used to indicate a time period in which the terminal device expects to receive a PRS. In some implementations, the foregoing first parameter may be determined based on a positioning measurement time window. For example, still refer to FIG. 15. The end location of the time domain range 1510 indicated by the first parameter may be determined based on a time domain end location of the positioning measurement time window. For another example, still refer to FIG. 15. The end location of the time domain range 1510 indicated by the first parameter may be a time domain end location of the positioning measurement time window.

The foregoing describes a manner of determining a first time domain location. In different sidelink resource allocation manners, the foregoing implementations of determining the first time domain location are different. The following descriptions are provided with reference to different sidelink resource allocation manners.

Sidelink resource allocation manner 1: in which a sidelink resource used for transmitting a sidelink positioning reference signal is configured by the network device.

In the sidelink resource allocation manner 1, the first sidelink resource and the second sidelink resource may be configured by the network device. Correspondingly, the network device may determine, based on the first parameter and the second time domain location corresponding to the second sidelink resource, the first time domain location corresponding to the first sidelink resource; and after the first sidelink resource is determined, transmit first information to the first terminal device and/or the second terminal device, to indicate the first sidelink resource and the second sidelink resource.

It should be noted that the first information may be directly transmitted by the network device to the first terminal device and the second terminal device. Certainly, in embodiments of this application, the first information may alternatively be transmitted by the network device to one of the terminal devices; and then, the terminal device may notify the other terminal device of the first information. For example, the first information may be transmitted by the network device to the first terminal device; and then, transmitted by the first terminal device to the second terminal device. For another example, the first information may be transmitted by the network device to the second terminal device; and then, transmitted by the second terminal device to the first terminal device.

In addition, the first information between the terminal devices may be transmitted through SCI. Certainly, the first information may be transmitted through other sidelink information or transmitted by using dedicated information, which is not limited in embodiments of this application.

For ease of understanding, the following describes a solution according to an embodiment of this application with reference to FIG. 15 by using an example in which the first parameter indicates a time interval threshold. Still refer to FIG. 15. After the network device determines that the second sidelink resource is the time unit n, the network device may determine the first sidelink resource in the time domain range 1510; and after the first sidelink resource is determined, the network device may transmit first information to the first terminal device and the second terminal device, where the first information is used to indicate the first sidelink resource and the second sidelink resource.

Sidelink resource allocation manner 2: in which the terminal device autonomously selects, from the sidelink resource pool, a sidelink resource used for transmitting a sidelink positioning reference signal.

In some implementations, the sidelink positioning reference signal and control information related to sidelink positioning (for example, the first information described below) may be multiplexed into a same time unit.

In some implementations, the first information may be carried by SCI in a PSCCH; and the first information may include a sidelink resource (or referred to as a reserved resource) used for transmitting a sidelink positioning reference signal in a current period and/or a transmission period of a sidelink positioning reference signal.

In some implementations, bandwidth of a reserved resource may be indicated by a frequency resource assignment field in the first information. In some other implementations, a time domain location of the reserved resource may be indicated by a time resource assignment field in the first information. In some other implementations, a transmission period of the sidelink positioning reference signal may be indicated by a resource reservation period field in the first information.

In embodiments of this application, the foregoing resource allocation manner may be classified into two cases. In Case 1, the second terminal device may select sidelink resources for the first terminal device and the second terminal device. In Case 2, each terminal device selects a sidelink resource to be used by itself. The following describes the two cases separately.

In Case 1, the second terminal device selects a first sidelink resource and a second sidelink resource.

In some implementations, the second terminal device may determine, based on a first parameter and a second time domain location corresponding to the second sidelink resource, a first time domain location corresponding to the first sidelink resource; and after the first sidelink resource is determined, transmit first information to the first terminal device, to indicate the first sidelink resource.

It should be noted that the first information may be transmitted through SCI. Certainly, the first information may be transmitted through other sidelink information or transmitted through dedicated information, which is not limited in embodiments of this application.

In embodiments of this application, the second terminal device may not only select a sidelink resource to be used by itself, but also select a sidelink resource for the first terminal device, so that the method in this embodiment of this application is applicable to a scenario in which the first terminal device does not have a resource selection function. This is beneficial to expand a scenario to which the method in this embodiment of this application is applicable.

Alternatively, the first sidelink resource and the second sidelink resource may be selected by the second terminal device via one resource selection process, which is beneficial to reduce a quantity of resource selection processes and shorten a time required by the resource selection process.

For ease of understanding, the following describes a solution according to an embodiment of this application with reference to FIG. 16 by using an example in which the first parameter indicates a time interval threshold. Refer to FIG. 16. It is assumed that the time interval threshold indicated by the first parameter is M time units, and that the second terminal device triggers sidelink resource selection in the time unit n. After determining that the second sidelink resource is a time unit x, the second terminal device may select the first sidelink resource before a time unit x+M based on the first parameter and the second time domain location of the second sidelink resource, that is, the second terminal device may select a time unit y as the first sidelink resource.

In this case, the second terminal device may transmit the second sidelink positioning reference signal in the time unit x; and reserve, for the first terminal device through SCI, the first sidelink resource located in the time unit y. Correspondingly, when receiving, in the time unit x, the second sidelink positioning reference signal and the SCI that are transmitted by the second terminal device, the first terminal device may obtain, based on successfully decoded SCI, the first sidelink resource reserved by the second terminal device for the first terminal device. Then, the first terminal device may transmit the first sidelink positioning reference signal by using the first sidelink resource, that is, the first terminal device transmits the first sidelink positioning reference signal in the time unit y.

In Case 2, the second terminal device selects a second sidelink resource; and the first terminal device selects a first sidelink resource.

In some implementations, the foregoing manner in which each terminal device selects a sidelink resource may use the resource selection manner that is described above. For example, after listening in a corresponding listening window, the terminal device performs selection in a corresponding resource selection window. Certainly, in embodiments of this application, each terminal device may alternatively select a sidelink resource in another manner, which is not limited in embodiments of this application.

In embodiments of this application, each terminal device may autonomously select a sidelink resource to be used by itself, which is beneficial to improve selection reasonableness of the sidelink resource.

In some implementations, the first terminal device may select the first sidelink resource in a first resource selection window, that is, the first time domain location is a time domain location in the first resource selection window. The first resource selection window is determined based on the second time domain location and the first parameter.

In some implementations, the second time domain location may be indicated by the second terminal device to the first terminal device. For example, the second terminal device may transmit first information to the first terminal device, to indicate the second sidelink resource. Certainly, in embodiments of this application, the second terminal device may alternatively indicate the second time domain location in another manner.

In some implementations, a start time of the first resource selection window is later than or equal to a first time unit; an end time of the first resource selection window is earlier than or equal to a second time unit; the first time unit is a time unit corresponding to the second time domain location; and the second time unit is determined based on the first time unit and the first parameter.

That the first time unit is a time unit corresponding to the second time domain location may be understood as that the first time unit is a time unit corresponding to the second sidelink resource. Correspondingly, the start time of the first resource selection window is later than or equal to a time unit corresponding to the second sidelink resource.

Assuming that the first time unit is the time unit n, and the time interval indicated by the first parameter is M time units, when the first terminal performs resource selection, the first resource selection window may be represented as [n+T1, n+T2], where a value of T1 is less than a value of T2, and the value of T2 is less than or equal to M.

In some implementations, selection of the first sidelink resource may be triggered by a sidelink reference signal transmitted by the second terminal device to the first terminal device. In other words, the second sidelink positioning reference signal transmitted by the second terminal device on the second sidelink resource is used to trigger the first terminal device to execute a resource selection process, thereby selecting the first sidelink resource. Certainly, in embodiments of this application, the second terminal device may transmit first information to the first terminal device, to indicate the second sidelink resource to the first terminal device; and accordingly, trigger the first terminal device to execute the foregoing resource selection process.

It should be noted that the first information may be transmitted through SCI. Certainly, the first information may be transmitted through other sidelink information or transmitted through dedicated information, which is not limited in embodiments of this application.

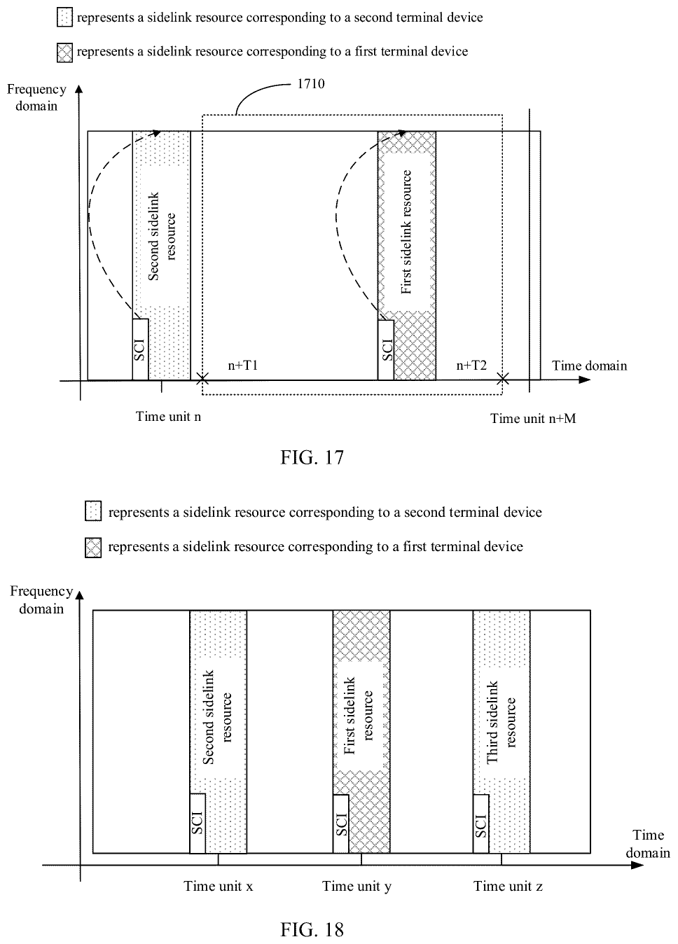

For ease of understanding, the following describes a solution according to an embodiment of this application with reference to FIG. 17 by using an example in which the first parameter indicates a time interval threshold. Refer to FIG. 17. It is assumed that the time unit n is the second sidelink resource selected by the second terminal device, and that the second terminal device transmits the second sidelink positioning reference signal on the second sidelink resource to the first terminal device. In this case, the time unit n is the first time unit; and if the time interval threshold indicated by the first parameter is M, the second time unit is the time unit n+M. In other words, the first resource selection window 1710 may be represented as [n+T1, n+T2], where a value of T1 is less than a value of T2, and the value of T2 is less than or equal to M. Correspondingly, after the first terminal device receives the second sidelink positioning reference signal, the first terminal device is triggered to perform resource selection in the first resource selection window.

In embodiments of this application, after the first terminal device and the second terminal device respectively select the first sidelink resource and the second sidelink resource, another terminal device may be indicated, by transmitting SCI, that the first sidelink resource and the second sidelink resource are reserved.

The foregoing describes a solution for determining a first sidelink resource based on a second sidelink resource according to an embodiment of this application. In some cases, the foregoing solution may be used in a single-sided RTT positioning scenario to determine two sidelink resources that are used for transmitting a sidelink positioning reference signal. In some other cases, there may be more sidelink positioning reference signals during positioning, that is, more sidelink resources need to be determined. For example, in the double-sided RTT-based positioning manner that is described above, at least three sidelink positioning reference signals need to be transmitted, that is, at least three sidelink resources need to be determined.

In the foregoing cases, a time domain location corresponding to a third sidelink resource (also referred to as a “third time domain location”) also needs to be considered during determining of the first time domain location, where the third sidelink resource is used to transmit a third sidelink positioning reference signal, and the third time domain location is later than the second time domain location. In other words, the first time domain location being determined based on the second time domain location may include: the first time domain location being determined based on the second time domain location and the third time domain location.

In some implementations, the first time domain location may be between the second time domain location and the third time domain location. In other words, the first sidelink resource is between the second sidelink resource and the third sidelink resource in time domain.

For ease of understanding, the following describes a solution according to an embodiment of this application with reference to FIG. 18 by using a double-sided RTT positioning scenario as an example. It is assumed that the second sidelink resource is the time unit x and is used by the second terminal device for transmitting the SL PRS 2 to the first terminal device, and that the third sidelink resource is a time unit z and is used by the second terminal device for transmitting an SL PRS 3 to the first terminal device. In this case, the first sidelink resource may be determined based on the time unit x and the time unit z, where the first sidelink resource is used by the first terminal device for transmitting the SL PRS 1 to the second terminal device. Correspondingly, the first sidelink resource may be the time unit y, and may be between the time unit x and the time unit z in time domain.

The foregoing describes a manner of determining a first time domain location based on a second time domain location and a third time domain location. In different sidelink resource allocation manners, the foregoing implementations of determining the first time domain location are different. The following descriptions are provided with reference to different sidelink resource allocation manners by using an example in which the first parameter indicates a time interval between two adjacent sidelink resources in the plurality of sidelink resources.

Sidelink resource allocation manner 1: in which a sidelink resource used for transmitting a sidelink positioning reference signal is configured by the network device.

In the sidelink resource allocation manner 1, the first sidelink resource, the second sidelink resource, and the third sidelink resource may be configured by the network device. Correspondingly, the network device may determine, based on the first parameter and the second time domain location corresponding to the second sidelink resource, the first time domain location corresponding to the first sidelink resource; and determine, based on the first parameter and the first time domain location corresponding to the first sidelink resource, the third time domain location corresponding to the third sidelink resource. Then, the network device may respectively determine the first sidelink resource, the second sidelink resource, and the third sidelink resource based on the first time domain location, the second time domain location, and the third time domain location.

In some implementations, the network device may transmit first information to the first terminal device and the second terminal device, thereby indicating the first sidelink resource, the second sidelink resource, and the third sidelink resource.

It should be noted that the first information may be directly transmitted by the network device to each terminal device. Certainly, in embodiments of this application, the first information may alternatively be transmitted by the network device to one of the terminal devices; and then, the terminal device may notify the other terminal device of the first information. For example, the first information may be transmitted by the network device to the first terminal device; and then, transmitted by the first terminal device to the second terminal device. For another example, the first information may be transmitted by the network device to the second terminal device; and then, transmitted by the second terminal device to the first terminal device.

In addition, when transmitting the first information, the terminal device may directly forward the first information transmitted by the network device. Certainly, the terminal device may alternatively process the first information, and then transmit processed information to the other terminal device. For example, if the second terminal device receives the first information transmitted by the network device, the second terminal device may notify the first terminal device of only the first sidelink resource. For another example, if the first terminal device receives the first information transmitted by the network device, the first terminal device may notify the second terminal device of only the second sidelink resource.

In some implementations, information between the terminal devices may be transmitted through SCI. Certainly, the first information may be transmitted through other sidelink information or transmitted through dedicated information, which is not limited in embodiments of this application.

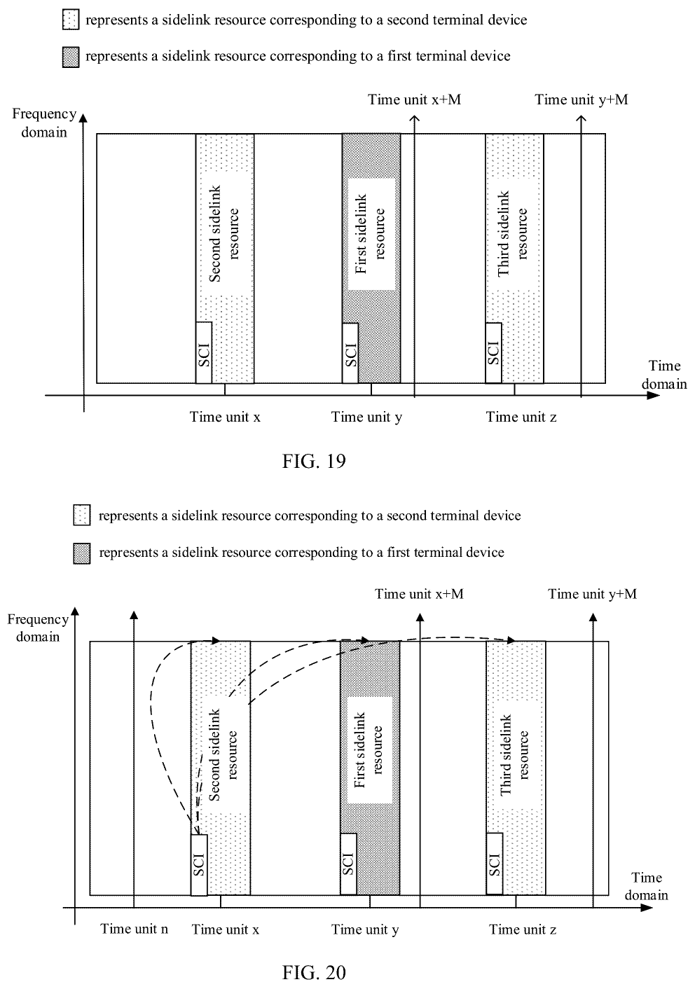

For ease of understanding, the following describes a solution according to an embodiment of this application with reference to FIG. 19 by using an example in which the first parameter indicates a time interval threshold between adjacent sidelink resources. Refer to FIG. 19. It is assumed that the first parameter indicates that the time interval threshold between the adjacent sidelink resources is M time units. After the network device determines that the second sidelink resource is the time unit x, the network device may determine, based on that a time interval between the first sidelink resource and the second sidelink resource is less than or equal to M time units, the first time domain location corresponding to the first sidelink resource, that is, the first sidelink resource is the time unit y, and the time unit y is earlier than the time unit x+M in time domain.

Then, the network device may determine, based on that a time interval between the first sidelink resource and the third sidelink resource is less than or equal to M time units, the third time domain location corresponding to the third sidelink resource, that is, the third sidelink resource is the time unit z, and the time unit z is earlier than a time unit y+M in time domain.

It should be noted that the foregoing description is provided by using an example in which first parameters corresponding to every two adjacent sidelink resources in the plurality of sidelink resources are the same. In embodiments of this application, first parameters corresponding to every two adjacent sidelink resources in the plurality of sidelink resources may be different. In other words, time interval thresholds corresponding to every two adjacent sidelink resources in the plurality of sidelink resources may be different. This is not limited in embodiments of this application.

Sidelink resource allocation manner 2: in which the terminal device autonomously selects, from the sidelink resource pool, a sidelink resource used for transmitting a sidelink positioning reference signal.

In embodiments of this application, the foregoing resource allocation manner may be classified into two cases. In Case 1, the second terminal device may select sidelink resources for the first terminal device and the second terminal device. In Case 2, each terminal device selects a sidelink resource to be used by itself. The following describes the two cases separately.

In Case 1, the second terminal device selects a first sidelink resource, a second sidelink resource, and a third sidelink resource.

In some implementations, the second terminal device may determine, based on a first parameter and a second time domain location corresponding to the second sidelink resource, a first time domain location corresponding to the first sidelink resource; and determine, based on the first time domain location and the first parameter, a third time domain location corresponding to the third sidelink resource. Then, the second terminal device may respectively determine the first sidelink resource, the second sidelink resource, and the third sidelink resource based on the first time domain location, the second time domain location, and the third time domain location.

In some implementations, the second terminal device may transmit first information to the first terminal device, to indicate the second sidelink resource. Certainly, in embodiments of this application, the first information may also indicate the first sidelink resource, the second sidelink resource, and the third sidelink resource. This is not limited in embodiments of this application.

It should be noted that the first information may be transmitted through SCI. Certainly, the first information may be transmitted through other sidelink information or transmitted through dedicated information, which is not limited in embodiments of this application.

In embodiments of this application, the second terminal device may not only select a sidelink resource to be used by itself, but also select a sidelink resource for the first terminal device, so that the method in this embodiment of this application is applicable to a scenario in which the first terminal device does not have a resource selection function. This is beneficial to expand a scenario to which the method in this embodiment of this application is applicable.

Alternatively, the first sidelink resource, the second sidelink resource, and the third sidelink resource may be selected by the second terminal device via one resource selection process, which is beneficial to reduce a quantity of resource selection processes and shorten a time required by the resource selection process.

For ease of understanding, the following describes a solution according to an embodiment of this application with reference to FIG. 20 by using an example in which the first parameter indicates a time interval threshold between adjacent sidelink resources. Refer to FIG. 20. It is assumed that the time interval threshold indicated by the first parameter is M time units, and that the second terminal device triggers sidelink resource selection in the time unit n. After determining that the second sidelink resource is a time unit x, the second terminal device may select the first sidelink resource before a time unit x+M based on the first parameter and the second time domain location of the second sidelink resource. If the second terminal device selects the time domain y as the first sidelink resource, the second terminal device may continue to select the third sidelink resource before the time unit y+M based on the first parameter and the first time domain location corresponding to the first sidelink resource. The second terminal device may select the time unit z as the third sidelink resource.

In this case, the second terminal device may transmit the second sidelink positioning reference signal in the time unit x; and reserve, for the first terminal device through SCI, the first sidelink resource located in the time unit y. Correspondingly, when the second terminal device transmits the second sidelink positioning reference signal and the SCI to the first terminal device in the time unit x, the first terminal device may obtain, based on successfully decoded SCI, the first sidelink resource reserved by the second terminal device for the first terminal device. Then, the first terminal device may transmit the first sidelink positioning reference signal by using the first sidelink resource, that is, the first terminal device transmits the first sidelink positioning reference signal in the time unit y.

In Case 2, the second terminal device selects a second sidelink resource and a third sidelink resource; and the first terminal device selects a first sidelink resource.

In some implementations, the foregoing manner in which each terminal device selects a sidelink resource may use the resource selection manner that is described above. For example, after listening in a corresponding listening window, the terminal device performs selection in a corresponding resource selection window. Certainly, in embodiments of this application, each terminal device may alternatively select a sidelink resource in another manner, which is not limited in embodiments of this application.

In embodiments of this application, each terminal device may autonomously select a sidelink resource to be used by itself, which is beneficial to improve selection reasonableness of the sidelink resource.

In some implementations, the first parameter may be used to determine a time interval between the second time domain location corresponding to the second sidelink resource and the third time domain location corresponding to the third sidelink resource. For example, the first parameter may be used to indicate a time interval threshold between the second time domain location and the third time domain location. Correspondingly, the second terminal device may determine the third time domain location based on the second time domain location and the first parameter.

In some implementations, the first terminal device may select the first sidelink resource in a second resource selection window, that is, the first time domain location is a time domain location in the second resource selection window. The second resource selection window is determined based on the second time domain location and the third time domain location.

In some implementations, a start time of the second resource selection window is later than or equal to a third time unit; an end time of the second resource selection window is earlier than or equal to a fourth time unit; the third time unit is a time unit corresponding to the second time domain location; and the fourth time unit is a time unit corresponding to the third time domain location.

That the third time unit is a time unit corresponding to the second time domain location may be understood as that the third time unit is a time unit corresponding to the second sidelink resource. Correspondingly, the start time of the second resource selection window is later than or equal to the time unit corresponding to the second sidelink resource. In other words, the start time of the second resource selection window is not earlier than the time unit corresponding to the second sidelink resource.

That the fourth time unit is a time unit corresponding to the third time domain location may be understood as that the fourth time unit is a time unit corresponding to the third sidelink resource. Correspondingly, the end time of the second resource selection window is earlier than or equal to a time unit corresponding to the third sidelink resource. In other words, the end time of the second resource selection window is not later than the time unit corresponding to the third sidelink resource.

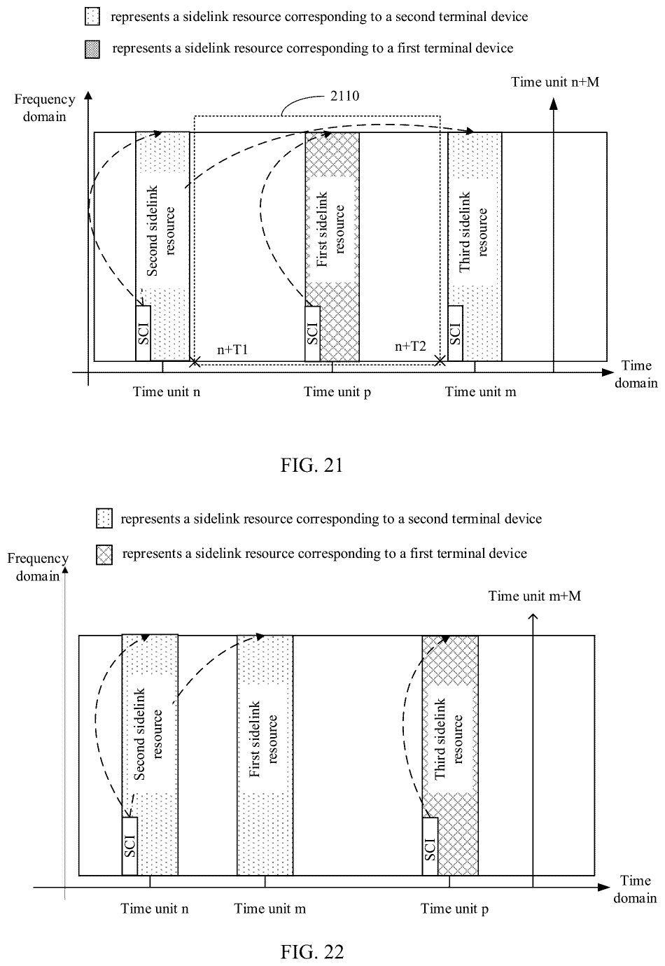

Refer to FIG. 21. It is assumed that the second time domain location corresponding to the second sidelink resource is the time unit n, and that a time interval indicated by the first parameter is M time units. In this case, the third time domain location corresponding to the third sidelink resource is the time unit m; and the time unit m is before the time unit n+M. Correspondingly, the start time of the second resource selection window is later than or equal to the time unit n; and the end time of the second resource selection window is earlier than or equal to the time unit m. In some implementations, the second resource selection window 2110 may be represented as [n+T1, n+T2], where a value of T1 is less than a value of T2, and the value of (n+T2) is less than or equal to m.

In some implementations, selection of the first sidelink resource may be triggered by a sidelink reference signal transmitted by the second terminal device to the first terminal device. In other words, the second sidelink positioning reference signal transmitted by the second terminal device on the second sidelink resource is used to trigger the first terminal device to execute a resource selection process, thereby selecting the first sidelink resource. Certainly, in embodiments of this application, the second terminal device may transmit first information to the first terminal device, to indicate the second sidelink resource to the first terminal device; and accordingly, trigger the first terminal device to execute the foregoing resource selection process.

It should be noted that the first information may be transmitted through SCI. Certainly, the first information may be transmitted through other sidelink information or transmitted through dedicated information, which is not limited in embodiments of this application.

For ease of understanding, the following describes a solution according to an embodiment of this application with reference to FIG. 21 by using an example in which the first parameter indicates a time interval threshold between the second sidelink resource and the third sidelink resource. Refer to FIG. 21. It is assumed that the time interval threshold indicated by the first parameter is M time units. If the second terminal device selects the time unit n as the second sidelink resource, the second terminal device may select a third sidelink resource based on the time unit n and the first parameter, where the third sidelink resource needs to be located before the time unit n+M in time domain. Correspondingly, the second terminal device may select the time unit m as the third sidelink resource.

In this case, the second terminal device may transmit the second sidelink positioning reference signal and the SCI to the first terminal device in the time unit n, where the SCI indicates that the second sidelink resource is the time unit n and that the third sidelink resource is the time unit m, and the second sidelink positioning reference signal is used to trigger the first terminal device to select the first sidelink resource.

Accordingly, in response to the second sidelink positioning reference signal, the first terminal device may select a time unit p in a second resource selection window 2110 as the first sidelink resource. The second resource selection window 2110 may be represented as [n+T1, n+T2], where a value of T1 is less than a value of T2, and the value of (n+T2) is less than or equal to m.

In some scenarios, to improve positioning accuracy, a sidelink positioning reference signal may be transmitted through a plurality of sidelink resources. For example, the second terminal device transmits the second sidelink positioning reference signal through a plurality of sidelink resources. In other words, the second sidelink resource is one of the plurality of sidelink resources, and all time domain locations corresponding to the plurality of sidelink resources are earlier than the first time domain location. In this case, the second time domain location corresponds to a sidelink resource with the latest time domain location in the plurality of sidelink resources. In other words, the first time domain location may be determined based on a time domain location corresponding to the sidelink resource with the latest time domain location in the plurality of sidelink resources. Certainly, in embodiments of this application, the second time domain location may correspond to a sidelink resource in the plurality of sidelink resources whose time domain location is the earliest one. Alternatively, the second time domain location may correspond to a sidelink resource at any time domain location of the plurality of sidelink resources. This is not limited in embodiments of this application.

Refer to FIG. 22. It is assumed that the first parameter indicates the time interval threshold between the first time domain location and the second time domain location being M, and that the plurality of sidelink resources include the time unit n and the time unit m that are used for transmitting a second sidelink positioning reference signal, where the time unit m is after the time unit n in time domain. In this case, the first sidelink resource may be selected based on the first parameter and the time domain location of the time unit m. In other words, a time domain location of the first sidelink resource (namely, the first time domain location) needs to be earlier than a time unit m+M.

It should be noted that, in embodiments of this application, the foregoing determining manner of determining a first time domain location may be used in combination with various sidelink resource allocation manners. For example, the method may be used in combination with configuring a sidelink resource by the network device. For another example, the method may be used in combination with a resource allocation manner in which the second terminal device selects all sidelink resources from the sidelink resource pool. For another example, the method may also be used in combination with a resource allocation manner in which the second terminal device and the first terminal device each select a sidelink resource to be used by itself.

The following provides a description by using, as an example, a resource allocation manner in which the second terminal device and the first terminal device each select a sidelink resource to be used by itself. In another resource allocation manner, a manner of determining a first time domain location is similar to the determining process described above with reference to FIG. 22. For brevity, details are not described below.

Still refer to FIG. 22. It is assumed that the first parameter indicates the time interval threshold between the first time domain location and the second time domain location being M. The second terminal device may select the time unit n and the time unit m as second sidelink resources through a resource selection mechanism, where the time unit m is after the time unit n in time domain. In other words, the time unit m is a sidelink resource that is reserved by the second terminal device for transmitting the second sidelink positioning reference signal last. Then, the second terminal device may transmit the second sidelink positioning reference signal and SCI in the time unit n, where the SCI is used to indicate that the second terminal device reserves the time unit n and the time unit m. In addition, the second terminal device may continue to transmit the second sidelink positioning reference signal in the time unit m, where the second sidelink positioning reference signal transmitted in the time unit m is used to trigger the first terminal device to perform resource selection.

Accordingly, after receiving the SCI in the time unit n, the first terminal device may learn that the second terminal device reserves the time unit n and the time unit m. In response to receiving the second sidelink positioning reference signal in the time unit m, the first terminal device selects a time unit p in a third resource selection window as the first sidelink resource. The third resource selection window may be represented as [m+T1, m+T2], where a value of T1 is less than a value of T2, and the value of T2 is less than or equal to M.

It should be noted that, in embodiments of this application, the foregoing time unit may be any type of time unit in a current communications system, for example, a slot, a symbol, a subframe, or a frame. Certainly, the foregoing time unit may also be a time unit introduced to a future communications system, which is not limited in embodiments of this application.

In addition, after a sidelink resource is determined, an SL PRS receiving end (for example, the first terminal device and/or the second terminal device) may determine, based on an SL PRS, a measurement quantity used for sidelink positioning, where the measurement quantity may be measurement quantities (namely, the measurement quantity 1 and the measurement quantity 2) in the RTT positioning solution described above. Certainly, a first measurement quantity described below may also be used, which is not limited in embodiments of this application.

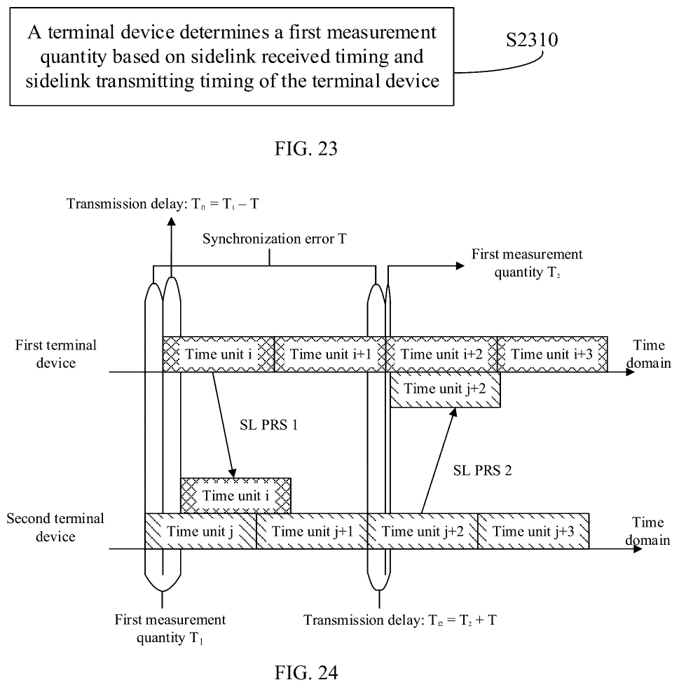

Currently, how to calculate a measurement quantity used for sidelink positioning is not specified in sidelink-based positioning. Therefore, in view of the foregoing problem, another embodiment of this application provides a method for sidelink positioning, to define a measurement quantity used for sidelink positioning. A method for sidelink positioning according to an embodiment of this application is described below with reference to FIG. 23. It should be noted that the method in this embodiment of this application may be used in combination with the foregoing method for determining a sidelink resource. Certainly, the method in this embodiment of this application may be used separately.

FIG. 23 is a schematic flowchart of a method for sidelink positioning according to an embodiment of this application. The method shown in FIG. 23 includes Step S2310.

In Step S2310, a terminal device determines a first measurement quantity based on sidelink received timing and sidelink transmitting timing of the terminal device.

In some implementations, the foregoing first measurement quantity may be used for sidelink positioning. For example, the foregoing first measurement quantity may be used as a measurement quantity in an RTT-based positioning method. In this case, the terminal device may be a target device in the RTT-based positioning method, or the terminal device may be a reference device in the RTT-based positioning method.

In a conventional RTT positioning solution, a difference between a transmitting time at which the target device transmits a PRS 1 and a receiving time at which the PRS 1 is received is used as a measurement quantity 1; and a difference between a receiving time at which the reference device receives the PRS 1 and a transmitting time at which a PRS 2 is transmitted is used as a measurement quantity 2. Therefore, the measurement quantity 1 and the measurement quantity 2 can be obtained only after transmission of the PRS 1 and the PRS 2 ends. Generally, a longer signal transmission time corresponding to an obtained measurement quantity may lead to a greater error of the measurement quantity. According to the method in this embodiment of this application, the first measurement quantity is determined based on the sidelink received timing and the sidelink transmitting timing. Compared with a measurement quantity specified in a conventional RTT positioning manner, each measurement quantity is obtained via a simplified process, which is beneficial to reduce an error in a process of obtaining the measurement quantity, thereby improving positioning accuracy.

In some implementations, the first measurement quantity may be determined based on a time difference between the sidelink received timing and the sidelink transmitting timing.

In some implementations, the sidelink received timing may be received timing of a first time unit. Refer to FIG. 23. The terminal device being a second terminal device is used as an example. The sidelink received timing may be received timing corresponding to a receiving time unit i of the second terminal device.

In some implementations, the foregoing first time unit may be used to carry a sidelink positioning reference signal (also referred to as a “first sidelink positioning reference signal”). Certainly, in embodiments of this application, the foregoing first time unit may also carry another sidelink signal, which is not limited in embodiments of this application.

In some implementations, the foregoing first time unit may be associated with a resource that transmits one or more sidelink positioning reference signals. The plurality of sidelink positioning reference signals may be a sidelink reference signal that is transmitted repeatedly, which is beneficial to improve positioning accuracy.

In some scenarios, the sidelink positioning reference signal may be transmitted through a plurality of transmission paths; and transmission delays corresponding to different transmission paths may be different. To avoid excessive errors introduced to a signal transmission process, a transmission path with the shortest transmission delay may be selected to determine sidelink received timing. In other words, the sidelink received timing is determined based on the first path detected by the terminal device. Certainly, in embodiments of this application, the sidelink received timing may also be determined based on a transmission path with the longest transmission delay, which is not limited in embodiments of this application.

In some implementations, the sidelink transmitting timing is transmitting timing of a second time unit; the second time unit belongs to a time unit set corresponding to timing of the terminal device; and the second time unit is a time unit in the time unit set that is closest to the first time unit. Still refer to FIG. 24. The terminal device being the second terminal device is used as an example. A time unit set corresponding to timing of the second terminal device includes a time unit j, a time unit j+1, . . . , and a time unit j+3. If the first time unit is the time unit i, a time unit in the time unit set that is closest to the time unit i is the time unit j.

In embodiments of this application, the distance between the time units may be determined based on borders of the time units, where the borders of the time units may include a start time and an end time of the time units. Certainly, in embodiments of this application, the distance between the time units may also be determined based on any instant in the time units.

A border of a time unit being a start time is used as an example. A time unit whose start time is closest to a start time of the first time unit may be selected from the time unit set. Still refer to FIG. 24. A start time of the time unit j in the time unit set is closest to a start time of the time unit i, that is, the time unit j is the second time unit.

A border of a time unit being an end time is used as an example. A time unit whose end time is closest to an end time of the first time unit may be selected from the time unit set. Still refer to FIG. 24. An end time of the time unit j in the time unit set is closest to an end time of the time unit i, that is, the time unit j is the second time unit.

As described above, at least two measurement quantities are required in an RTT-based positioning method. The target device may be used as the foregoing terminal device; and the first measurement quantity of the target device is determined according to the foregoing method. In addition, the reference device may also be used as the foregoing terminal device; and the first measurement quantity of the reference device is determined according to a method in embodiments of this application. Correspondingly, the target device may be positioned based on the first measurement quantity of the target device and the first measurement quantity of the reference device.

In some scenarios, there may be a synchronization error between the reference device and the target device. The first measurement quantity of the target device that is obtained according to the foregoing method is determined based on a transmission delay and the synchronization error. Still refer to FIG. 24. The target device being the second terminal device is used as an example. A first measurement quantity T₁ determined by the second terminal device may be represented as a sum of a transmission delay T_{f1} and the synchronization error T. Correspondingly, the first measurement quantity of the reference device that is obtained according to the foregoing method is also determined based on a transmission delay and the synchronization error. Still refer to FIG. 24. The reference device being the first terminal device is used as an example. A first measurement quantity T₂ determined by the first terminal device may be represented as a value remained after the synchronization error T is subtracted from a transmission delay T_{f2}.

It may be learned from the foregoing description that, when the target device can be positioned based on the first measurement quantity of the target device and the first measurement quantity of the reference device, the first measurement quantity of the target device may be directly added to the first measurement quantity of the reference device. In this way, the synchronization error between the target device and the reference device may be offset directly, thereby improving positioning accuracy.

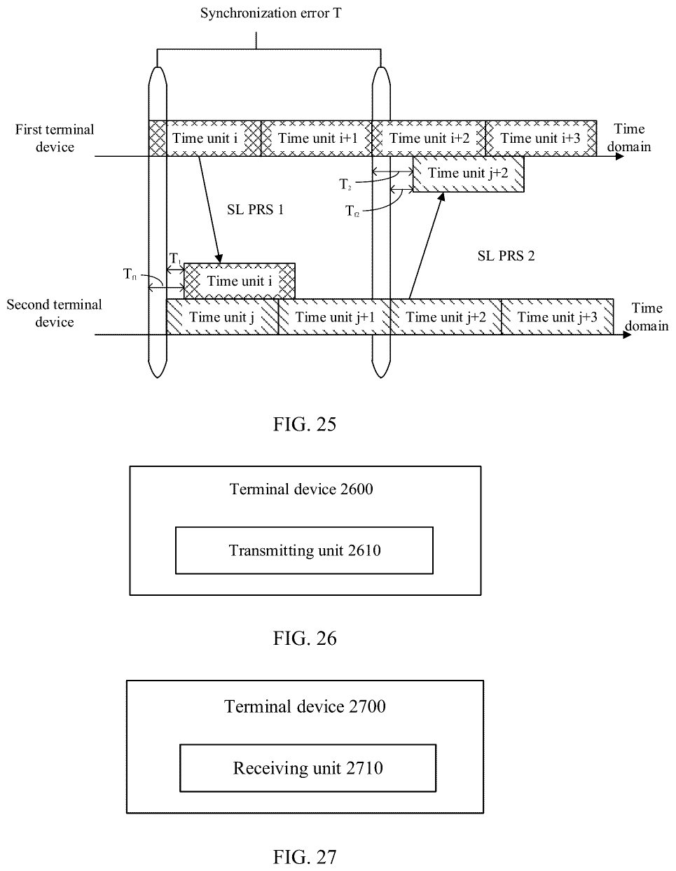

For ease of understanding, the following describes a method according to an embodiment of this application with reference to FIG. 24 and FIG. 25.

Refer to FIG. 24. It is assumed that the synchronization error between the first terminal device and the second terminal device is an advanced time T of the first terminal device relative to the second terminal device. In addition, timing of the first terminal device is the time unit i, a time unit i+1, . . . , or a time unit i+3; and timing of the second terminal device is the time unit j, the time unit j+1, . . . , or the time unit j+3.

The first terminal device transmits the SL PRS 1 in the time unit i; the second terminal device receives the SL PRS 1 after the transmission delay T_{f1}; and the second terminal device may determine the start time of the time unit i based on a receiving time of the SL PRS 1. Then, the second terminal device finds, in its own timing, a time unit that is closest to the start time of the time unit i, namely, the time unit j. The second terminal device may determine the first measurement quantity T₁ based on the start time of the time unit i and the start time of the time unit j that are calculated, where T₁=T_{f1}+T.

The second terminal device transmits the SL PRS 2 in the time unit j+2; the first terminal device receives the SL PRS 2 after the transmission delay T_{f2}; and the first terminal device may determine a start time of the time unit j+2 based on a receiving time of the SL PRS 2. Then, the first terminal device finds, in its own timing, a time unit that is closest to the start time of the time unit j+2, namely, the time unit i+2. The first terminal device may determine the first measurement quantity T₂ based on the start time of the time unit j+2 and a start time of the time unit i+2 that are calculated, where T₂=T_{f2}−T.

Correspondingly, a transmission delay average T_{f} of the SL PRS 2 and the SL PRS 1 may be determined based on the formula T_{f}=(T₁+T₂)/2. In this way, positioning may be performed based on the transmission delay T_{f} by using the RTT positioning method.

In a conventional RTT positioning solution, a difference between a transmitting time at which the target device transmits a PRS 1 and a receiving time at which the PRS 1 is received is used as a measurement quantity 1; and a difference between a receiving time at which the reference device receives the PRS 1 and a transmitting time at which a PRS 2 is transmitted is used as a measurement quantity 2. Therefore, the measurement quantity 1 and the measurement quantity 2 can be obtained only after transmission of the PRS 1 and the PRS 2 ends. Generally, a longer signal transmission time corresponding to an obtained measurement quantity may lead to a greater error of the measurement quantity. According to the method in this embodiment of this application, a first measurement quantity may be obtained after an SL PRS is transmitted from a transmitting end to a receiving end (for example, transmitted from the first terminal device to the second terminal device or transmitted from the second terminal device to the first terminal device), which shortens a signal transmission time corresponding to the first measurement quantity, thereby being beneficial to reduce an error in obtaining the first measurement quantity, and improving accuracy of sidelink positioning based on the first measurement quantity.

Refer to FIG. 25. It is assumed that the synchronization error between the first terminal device and the second terminal device is a postponed time T of the first terminal device relative to the second terminal device. In addition, timing of the first terminal device is the time unit i, a time unit i+1, . . . , or a time unit i+3; and timing of the second terminal device is the time unit j, the time unit j+1, . . . , or the time unit j+3.

The first terminal device transmits the SL PRS 1 in the time unit i; the second terminal device receives the SL PRS 1 after the transmission delay T_{f1}; and the second terminal device may determine the start time of the time unit i based on a receiving time of the SL PRS 1. Then, the second terminal device finds, in its own timing, a time unit that is closest to the start time of the time unit i, namely, the time unit j. The second terminal device may determine the first measurement quantity T₁ based on the start time of the time unit i and the start time of the time unit j that are calculated, where T₁=T_{f1}−T.

The second terminal device transmits the SL PRS 2 in the time unit j+2; the first terminal device receives the SL PRS 2 after the transmission delay T_{f2}; and the first terminal device may determine a start time of the time unit j+2 based on a receiving time of the SL PRS 2. Then, the first terminal device finds, in its own timing, a time unit that is closest to the start time of the time unit j+2, namely, the time unit i+2. The first terminal device may determine the first measurement quantity T₂ based on the start time of the time unit j+2 and a start time of the time unit i+2 that are calculated, where T₂=T_{f2}+T.

Correspondingly, a transmission delay average T_{f} of the SL PRS 2 and the SL PRS 1 may be determined based on the formula T_{f}=(T₁+T₂)/2. In this way, positioning may be performed based on the transmission delay T_{f} by using the RTT positioning method.

In a conventional RTT positioning solution, a difference between a transmitting time at which the target device transmits a PRS 1 and a receiving time at which the PRS 1 is received is used as a measurement quantity 1; and a difference between a receiving time at which the reference device receives the PRS 1 and a transmitting time at which a PRS 2 is transmitted is used as a measurement quantity 2. Therefore, the measurement quantity 1 and the measurement quantity 2 can be obtained only after transmission of the PRS 1 and the PRS 2 ends. Generally, a longer signal transmission time corresponding to an obtained measurement quantity may lead to a greater error of the measurement quantity. According to the method in this embodiment of this application, a first measurement quantity may be obtained after an SL PRS is transmitted from a transmitting end to a receiving end (for example, transmitted from the first terminal device to the second terminal device or transmitted from the second terminal device to the first terminal device), which shortens a signal transmission time corresponding to the first measurement quantity, thereby being beneficial to reduce an error in obtaining the first measurement quantity, and improving accuracy of sidelink positioning based on the first measurement quantity.

It should be noted that, in embodiments of this application, the foregoing time unit may be any type of time unit in a known communications system, for example, a sidelink subframe, a sidelink slot, or a sidelink symbol. Certainly, the foregoing time unit may also be a new time unit introduced to a future communications system, which is not limited in embodiments of this application.

In addition, when an SL PRS receiving end (for example, the first terminal device or the second terminal device) calculates a border of a time unit, the SL PRS receiving end may perform calculation based on a location of a time domain resource occupied during transmission of the SL PRS and a receiving time of the SL PRS. Certainly, in embodiments of this application, the SL PRS receiving end may also perform calculation in another manner, which is not specifically limited in embodiments of this application.

The method embodiments of this application are described above in detail with reference to FIG. 1 to FIG. 25. Apparatus embodiments of this application are described below in detail with reference to FIG. 26 to FIG. 30. It should be understood that the description of the method embodiments corresponds to the description of the apparatus embodiments, and therefore, for parts that are not described in detail, refer to the foregoing method embodiments.

FIG. 26 is a schematic diagram of a terminal device according to an embodiment of this application. The terminal device 2600 shown in FIG. 26 may be a first terminal device. The terminal device 2600 includes a transmitting unit 2610.

The transmitting unit 2610 is configured to transmit a first sidelink positioning reference signal to a second terminal device by using a first sidelink resource.

The first sidelink resource is configured by a network device, or the first sidelink resource is selected by the first terminal device or the second terminal device from a sidelink resource pool.

In a possible implementation, the first sidelink resource corresponds to a first time domain location; and the first time domain location is determined based on one or more of the following: a second time domain location, where the second time domain location corresponds to a second sidelink resource, the second sidelink resource is used to transmit a second sidelink positioning reference signal, and the second time domain location is earlier than the first time domain location; a positioning measurement time window of the first terminal device; a positioning measurement time window of the second terminal device; a terminal capability of the first terminal device; or a terminal capability of the second terminal device.

In a possible implementation, the first time domain location being determined based on the second time domain location includes: the first time domain location being determined based on the second time domain location and a first parameter, where the first parameter is used to determine a time interval between the first time domain location and the second time domain location.

In a possible implementation, the first parameter indicates a time interval threshold between the first time domain location and the second time domain location.

In a possible implementation, the first parameter is determined based on one or more of the following: a pre-definition in a protocol, pre-configuration information, configuration information of the network device, terminal configuration information of the first terminal device, terminal configuration information of the second terminal device, the positioning measurement time window of the first terminal device, or the positioning measurement time window of the second terminal device.

In a possible implementation, the first time domain location is a time domain location in a first resource selection window; and the first resource selection window is determined based on the second time domain location and the first parameter.

In a possible implementation, a start time of the first resource selection window is later than or equal to a first time unit; an end time of the first resource selection window is earlier than or equal to a second time unit; the first time unit is a time unit corresponding to the second time domain location; and the second time unit is determined based on the first time unit and the first parameter.

In a possible implementation, the second sidelink resource is one of a plurality of sidelink resources; all time domain locations corresponding to the plurality of sidelink resources are earlier than the first time domain location; and the second time domain location corresponds to a sidelink resource with the latest time domain location in the plurality of sidelink resources.

In a possible implementation, the first time domain location being determined based on the second time domain location includes:
the first time domain location being determined based on the second time domain location and a third time domain location, where the third time domain location corresponds to a third sidelink resource; the third sidelink resource is used to transmit a third sidelink positioning reference signal; and the third time domain location is later than the second time domain location.

In a possible implementation, the first time domain location is between the second time domain location and the third time domain location.

In a possible implementation, the terminal device further includes: a first receiving unit, configured to receive first information transmitted by the second terminal device, where the first information is used to indicate the first sidelink resource, the second sidelink resource, and the third sidelink resource.

In a possible implementation, the terminal device further includes: a second receiving unit, configured to receive first information transmitted by the second terminal device, where the first information is used to indicate the second sidelink resource and the third sidelink resource; and a first processing unit, configured to select the first sidelink resource based on the second time domain location corresponding to the second sidelink resource and the third time domain location corresponding to the third sidelink resource.

In a possible implementation, the terminal device further includes: a third receiving unit, configured to receive first information transmitted by the second terminal device, where the first information is used to indicate the second sidelink resource; and a second processing unit, configured to select the first sidelink resource based on the second time domain location corresponding to the second sidelink resource.

In a possible implementation, the terminal device further includes: a fourth receiving unit, configured to receive first information transmitted by the second terminal device, where the first information is used to indicate the first sidelink resource.

In a possible implementation, the first information is carried in sidelink control information.

In a possible implementation, the first sidelink resource is selected by the first terminal device; and selection of the first sidelink resource is triggered by a sidelink reference signal transmitted by the second terminal device to the first terminal device.

In a possible implementation, the first sidelink positioning reference signal is used to position the first terminal device and/or the second terminal device; and the positioning includes round-trip time-based positioning.

FIG. 27 is a schematic diagram of a terminal device according to an embodiment of this application. The terminal device 2700 shown in FIG. 27 may be a second terminal device. The terminal device 2700 includes a receiving unit 2710.

The receiving unit 2710 is configured to receive, by using a first sidelink resource, a first sidelink positioning reference signal transmitted by a first terminal device, where the first sidelink resource is configured by a network device, or the first sidelink resource is selected by the first terminal device or the second terminal device from a sidelink resource pool.

In a possible implementation, the first sidelink resource corresponds to a first time domain location; and the first time domain location is determined based on one or more of the following: a second time domain location, where the second time domain location corresponds to a second sidelink resource, the second sidelink resource is used to transmit a second sidelink positioning reference signal, and the second time domain location is earlier than the first time domain location; a positioning measurement time window of the first terminal device; a positioning measurement time window of the second terminal device; a terminal capability of the first terminal device; or a terminal capability of the second terminal device.

In a possible implementation, the first time domain location being determined based on the second time domain location includes: the first time domain location being determined based on the second time domain location and a first parameter, where the first parameter is used to determine a time interval between the first time domain location and the second time domain location.

In a possible implementation, the first parameter indicates a time interval threshold between the first time domain location and the second time domain location.

In a possible implementation, the first parameter is determined based on one or more of the following: a pre-definition in a protocol, pre-configuration information, configuration information of the network device, terminal configuration information of the first terminal device, terminal configuration information of the second terminal device, the positioning measurement time window of the first terminal device, or the positioning measurement time window of the second terminal device.

In a possible implementation, the first time domain location is a time domain location in a first resource selection window; and the first resource selection window is determined based on the second time domain location and the first parameter.

In a possible implementation, a start time of the first resource selection window is later than or equal to a first time unit; an end time of the first resource selection window is earlier than or equal to a second time unit; the first time unit is a time unit corresponding to the second time domain location; and the second time unit is determined based on the first time unit and the first parameter.

In a possible implementation, the second sidelink resource is one of a plurality of sidelink resources; all time domain locations corresponding to the plurality of sidelink resources are earlier than the first time domain location; and the second time domain location corresponds to a sidelink resource with the latest time domain location in the plurality of sidelink resources.

In a possible implementation, the first time domain location being determined based on the second time domain location includes: the first time domain location being determined based on the second time domain location and a third time domain location, where the third time domain location corresponds to a third sidelink resource; the third sidelink resource is used to transmit a third sidelink positioning reference signal; and the third time domain location is later than the second time domain location.

In a possible implementation, the first time domain location is between the second time domain location and the third time domain location.

In a possible implementation, the terminal device further includes: a first transmitting unit, configured to transmit first information to the first terminal device, where the first information is used to indicate the first sidelink resource, the second sidelink resource, and the third sidelink resource.

In a possible implementation, the terminal device further includes: a second transmitting unit, configured to transmit first information to the first terminal device, where the first information is used to indicate the second sidelink resource and the third sidelink resource.

In a possible implementation, the terminal device further includes: a third transmitting unit, configured to transmit first information to the first terminal device, where the first information is used to indicate the second sidelink resource.

In a possible implementation, the terminal device further includes: a fourth transmitting unit, configured to transmit first information to the first terminal device, where the first information is used to indicate that the first sidelink resource is reserved for the first terminal device.

In a possible implementation, the first information is carried in sidelink control information.

In a possible implementation, the first sidelink resource is selected by the first terminal device; and selection of the first sidelink resource is triggered by a sidelink reference signal transmitted by the second terminal device to the first terminal device.

In a possible implementation, the first sidelink positioning reference signal is used to position the first terminal device and/or the second terminal device; and the positioning includes round-trip time-based positioning.

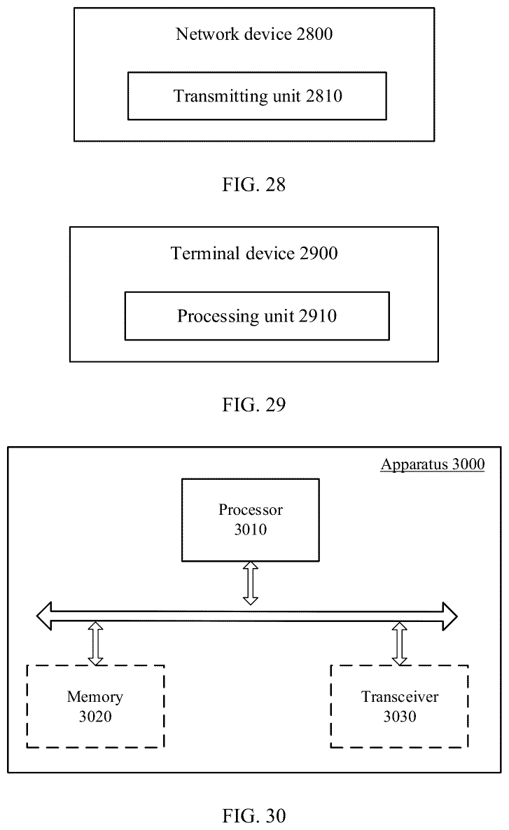

FIG. 28 is a schematic diagram of a network device according to an embodiment of this application. The network device 2800 shown in FIG. 28 includes a transmitting unit 2810.

The transmitting unit 2810 is configured to transmit configuration information to a first terminal device and/or a second terminal device, where the configuration information is used to configure a sidelink resource used for transmitting a sidelink positioning reference signal.

In a possible implementation, the sidelink resource configured by the configuration information includes a first sidelink resource and a second sidelink resource; the first sidelink resource corresponds to a first time domain location; the second sidelink resource corresponds to a second time domain location; and the first time domain location is determined based on one or more of the following: the second time domain location, where the second time domain location is earlier than the first time domain location; a positioning measurement time window of the first terminal device; a positioning measurement time window of the second terminal device; a terminal capability of the first terminal device; or a terminal capability of the second terminal device.

In a possible implementation, the first time domain location being determined based on the second time domain location includes: the first time domain location being determined based on the second time domain location and a first parameter, where the first parameter is used to determine a time interval between the first time domain location and the second time domain location.

In a possible implementation, the first parameter indicates a time interval threshold between the first time domain location and the second time domain location.

In a possible implementation, the first parameter is determined based on one or more of the following: a pre-definition in a protocol, pre-configuration information, configuration information of the network device, terminal configuration information of the first terminal device, terminal configuration information of the second terminal device, the positioning measurement time window of the first terminal device, or the positioning measurement time window of the second terminal device.

In a possible implementation, the second sidelink resource is one of a plurality of sidelink resources; all time domain locations corresponding to the plurality of sidelink resources are earlier than the first time domain location; and the second time domain location corresponds to a sidelink resource with the latest time domain location in the plurality of sidelink resources.

In a possible implementation, the first time domain location being determined based on the second time domain location includes: the first time domain location being determined based on the second time domain location and a third time domain location, where the third time domain location corresponds to a third sidelink resource; the third sidelink resource is used to transmit a third sidelink positioning reference signal; and the third time domain location is later than the second time domain location.

In a possible implementation, the first time domain location is between the second time domain location and the third time domain location.

In a possible implementation, the first sidelink positioning reference signal is used to position the first terminal device and/or the second terminal device; and the positioning includes round-trip time-based positioning.

FIG. 29 is a schematic diagram of a terminal device according to an embodiment of this application. The terminal device 2900 shown in FIG. 29 may include a processing unit 2910.

The processing unit 2910 is configured to determine a first measurement quantity based on sidelink received timing and sidelink transmitting timing of the terminal device.

In a possible implementation, the first measurement quantity is determined based on a time difference between the sidelink received timing and the sidelink transmitting timing.

In a possible implementation, the sidelink received timing is received timing of a first time unit; the sidelink transmitting timing is transmitting timing of a second time unit; the second time unit belongs to a time unit set corresponding to timing of the terminal device; and the second time unit is a time unit in the time unit set that is closest to the first time unit.

In a possible implementation, the sidelink received timing is associated with a first path detected by the terminal device.

In a possible implementation, the first time unit is used to carry a first sidelink positioning reference signal.

In a possible implementation, the first time unit is associated with a resource that transmit one or more first sidelink positioning reference signal.

In a possible implementation, the sidelink positioning includes round-trip time-based sidelink positioning.

In an optional embodiment, the transmitting unit 2610 may be a transceiver 3040. The terminal device 2600 may further include a processor 3010 and a memory 3020. Details are shown in FIG. 30.

In an optional embodiment, the receiving unit 2710 may be a transceiver 3040. The terminal device 2700 may further include a processor 3010 and a memory 3020. Details are shown in FIG. 30.

In an optional embodiment, the transmitting unit 2810 may be a transceiver 3040. The network device 2800 may further include the processor 3010 and the memory 3020. Details are shown in FIG. 30.

In an optional embodiment, the processing unit 2910 may be a processor 3010. The terminal device 2900 may further include a transceiver 3030 and a memory 3020. Details are shown in FIG. 30.

FIG. 30 is a schematic structural diagram of a communications apparatus according to an embodiment of this application. Dashed lines in FIG. 30 indicate that the units or modules are optional. The apparatus 3000 may be configured to implement the methods described in the foregoing method embodiments. The apparatus 3000 may be a chip, a terminal device, or a network device.

The apparatus 3000 may include one or more processors 3010. The processor 3010 may allow the apparatus 3000 to implement a method described in the foregoing method embodiments. The processor 3010 may be a general-purpose processor or a dedicated processor. For example, the processor may be a central processing unit (CPU). Alternatively, the processor may be another general-purpose processor, a digital signal processor (digital signal processor, DSP), an application specific integrated circuit (ASIC), a field-programmable gate array (FPGA) or another programmable logic device, a discrete gate or transistor logic device, a discrete hardware component, or the like. The general-purpose processor may be a microprocessor, or the processor may be any conventional processor or the like.

The apparatus 3000 may further include one or more memories 3020. The memory 3020 stores a program. The program may be executed by the processor 3010, to cause the processor 3010 to execute a method described in the foregoing method embodiments. The memory 3020 may be separated from the processor 3010 or may be integrated into the processor 3010.

The apparatus 3000 may further include a transceiver 3030. The processor 3010 may communicate with another device or chip through the transceiver 3030. For example, the processor 3010 may transmit data to and receive data from another device or chip through the transceiver 3030.

An embodiment of this application further provides a computer-readable storage medium for storing a program. The computer-readable storage medium may be applied to a terminal or a network device provided in embodiments of this application; and the program causes a computer to execute a method to be executed by a terminal or a network device in various embodiments of this application.

An embodiment of this application further provides a computer program product. The computer program product includes a program. The computer program product may be applied to a terminal or a network device provided in embodiments of this application; and the program causes a computer to execute methods to be executed by a terminal or a network device in various embodiments of this application.

An embodiment of this application further provides a computer program. The computer program may be applied to a terminal or a network device provided in embodiments of this application; and the computer program causes a computer to execute methods to be executed by a terminal or a network device in various embodiments of this application.

In embodiments of this application, positioning of a target terminal device may be implemented by using a measurement quantity (for example, the first measurement quantity) in embodiments of this application and/or a sidelink resource selection manner in embodiments of this application. Positioning may include relative positioning or absolute positioning described above.

It should be understood that the terms “system” and “network” in this application may be used interchangeably. In addition, the terms used in this application are only used to illustrate specific embodiments of this application, but are not intended to limit this application. The terms “first”, “second”, “third”, “fourth”, and the like in the specification, claims, and accompanying drawings of this application are used to distinguish between different objects, rather than to describe a specific order. In addition, the terms “include” and “have” and any variations thereof are intended to cover a non-exclusive inclusion.

In embodiments of this application, “indicate” mentioned herein may refer to a direct indication, or may refer to an indirect indication, or may mean that there is an association relationship. For example, A indicates B, which may mean that A directly indicates B, for example, B may be obtained through A; or may mean that A indirectly indicates B, for example, A indicates C, and B may be obtained through C; or may mean that there is an association relationship between A and B.

In embodiments of this application, “B corresponding to A” means that B is associated with A, and B may be determined based on A. However, it should also be understood that determining B based on A does not mean determining B based only on A, but instead B may be determined based on A and/or other information.

In embodiments of this application, the term “corresponding” may mean that there is a direct or indirect correspondence between two elements, or that there is an association relationship between two elements, or that there is a relationship of “indicating” and “being indicated”, “configuring” and “being configured”, or the like.

In embodiments of this application, “pre-defined” or “pre-configured” may be implemented by pre-storing corresponding codes, tables, or other forms that can be used to indicate related information in devices (for example, including the terminal device and the network device), and a specific implementation thereof is not limited in this application. For example, being pre-defined may refer to being defined in a protocol.

In embodiments of this application, the “protocol” may be a standard protocol in the communications field, and may include, for example, an LTE protocol, an NR protocol, and a related protocol applied to a future communications system, which is not limited in this application.

In embodiments of this application, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

In embodiments of this application, sequence numbers of the foregoing processes do not mean execution sequences. The execution sequences of the processes should be determined according to functions and internal logic of the processes, and should not be construed as any limitation on the implementation processes of embodiments of this application.

In several embodiments provided in this application, it should be understood that the disclosed system, apparatus, and method may be implemented in other manners. For example, the described apparatus embodiments are merely examples. For example, unit division is merely logical function division and may be other division in actual implementation. For example, a plurality of units or components may be combined or integrated into another system, or some features may be ignored or not executed. In addition, the displayed or discussed mutual couplings or direct couplings or communication connections may be implemented through some interfaces. The indirect couplings or communication connections between apparatuses or units may be implemented in electrical, mechanical, or other forms.

Units described as separate components may be or may not be physically separate, and components displayed as units may be or may not be physical units, and may be located in one position or distributed on a plurality of network units. Some or all of the units may be selected according to actual needs to achieve an objective of a solution in embodiments.

In addition, functional units in various embodiments of this application may be integrated into one processing unit, or each of the units may exist alone physically, or two or more units may be integrated into one unit.

All or some of the foregoing embodiments may be implemented through software, hardware, firmware, or any combination thereof. When software is used to implement embodiments, all or some of the embodiments may be implemented in a form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) manner or a wireless (for example, infrared, wireless, or microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid state disk (SSD)), or the like.

The foregoing descriptions are merely specific implementations of this application, but the protection scope of this application is not limited thereto. Any variation or replacement readily figured out by persons skilled in the art within the technical scope disclosed in this application shall fall within the protection scope of this application. Therefore, the protection scope of this application shall be subject to the protection scope of the claims.

What is claimed is:

1. A method for sidelink positioning, comprising:
determining, by a terminal device, a first measurement quantity based on sidelink received timing and sidelink transmitting timing of the terminal device.

2. The method according to claim 1, wherein the first measurement quantity is determined based on a time difference between the sidelink received timing and the sidelink transmitting timing.

3. The method according to claim 1, wherein the sidelink received timing is received timing of a first time unit; the sidelink transmitting timing is transmitting timing of a second time unit; the second time unit belongs to a time unit set corresponding to timing of the terminal device; and the second time unit is a time unit in the time unit set that is closest to the first time unit.

4. The method according to claim 3, wherein the sidelink received timing is associated with a first path detected by the terminal device.

5. The method according to claim 4, wherein the sidelink received timing is determined based on the first path detected by the terminal device.

6. The method according to claim 4, wherein the first time unit is used to carry a first sidelink positioning reference signal.

7. The method according to claim 1, wherein the sidelink positioning comprises round-trip time-based sidelink positioning.

8. A terminal device, comprising:
a processor and a memory, wherein the memory is configured to store a computer program, and the processor is configured to invoke and run the computer program stored in the memory to cause the first device to perform:
determining, a first measurement quantity based on sidelink received timing and sidelink transmitting timing of the terminal device.

9. The terminal device according to claim 8, wherein the first measurement quantity is determined based on a time difference between the sidelink received timing and the sidelink transmitting timing.

10. The terminal device according to claim 8, wherein the sidelink received timing is received timing of a first time unit; the sidelink transmitting timing is transmitting timing of a second time unit; the second time unit belongs to a time unit set corresponding to timing of the terminal device; and the second time unit is a time unit in the time unit set that is closest to the first time unit.

11. The terminal device according to claim 10, wherein the sidelink received timing is associated with a first path detected by the terminal device.

12. The method according to claim 11, wherein the sidelink received timing is determined based on the first path detected by the terminal device.

13. The terminal device according to claim 11, wherein the first time unit is used to carry a first sidelink positioning reference signal.

14. The terminal device according to claim 8, wherein the sidelink positioning comprises round-trip time-based sidelink positioning.
